(19) United States
(12) Patent Application Publication
(10) Pub. No.: US 2025/0257854 A1
(43) Pub. Date: Aug. 14, 2025

(54) HYBRID LIGHT TOWER

(71) Applicant: Briggs & Stratton, LLC, Wauwatosa, WI (US)

(72) Inventors: Andy Grasz, Holdrege, NE (US); Andrew Joestgen, Oak Creek, WI (US); Tony Shoemaker, Wauwatosa, WI (US); Melissa Erickson, Pewaukee, WI (US); Bryce Metcalf, New Berlin, WI (US); Eric Behrendt, Wauwatosa, WI (US); David Dooley, Wauwatosa, WI (US); Ryan McDermott, Wauwatosa, WI (US)

(21) Appl. No.: 19/054,338

(22) Filed: Feb. 14, 2025

Related U.S. Application Data
(60) Provisional application No. 63/553,593, filed on Feb. 14, 2024.
(60) Provisional application No. 63/696,238, filed on Sep. 18, 2024.

(51) Int. Cl. F21L 13/00; F21L 4/08; F21L 14/04; H02J 7/00; H02J 7/16

(52) U.S. Cl. CPC F21L 13/00; F21L 4/08; F21L 14/04; H02J 7/0045; H02J 7/0068; H02J 7/007194; H02J 7/16

(57) ABSTRACT

A hybrid light tower includes an engine, a mast, a generator configured to be driven by the engine, a battery coupled to the generator, a light assembly having a light, and a controller in communication with the battery, the engine, and the light assembly. The controller is configured to operate in a hybrid mode where the controller is configured to monitor a cell voltage of the battery, determine if the cell voltage of the battery is below a charging threshold, upon determining that the cell voltage of the battery is below the charging threshold, start the engine and charge the battery in a constant current mode, while charging in the constant current mode, determine if the cell voltage is above a constant voltage threshold, and upon determining that the cell voltage is above a constant voltage threshold, charge the battery in a constant voltage mode.

### CROSS-REFERENCE TO RELATED PATENT APPLICATIONS

This application claims the benefit of and priority to U.S. Provisional Patent Application No. 63/696,238, filed Sep. 18, 2024, and U.S. Provisional Patent Application No. 63/553,593, filed Feb. 14, 2024, each of which is incorporated herein by reference in its entirety.

### BACKGROUND

Conventional portable light towers typically include one or more lights attached to a movable base.

### SUMMARY

At least one embodiment relates to a hybrid light tower, including: an engine; a mast; a generator configured to be driven by the engine; a battery coupled to the generator; a light assembly coupled to the mast and including a light, wherein the light is configured to be powered by the battery or the generator; and a controller in communication with the battery, the engine, and the light assembly, wherein the controller is configured to operate in an engine mode where the generator supplies power to the light, a battery mode where the battery supplies power to the light, or a hybrid mode where the battery supplies power to the light, in the hybrid mode, the controller is configured to: monitor a state of charge (SOC) of the battery; determine if the SOC of the battery is below a lower threshold; if the SOC of the battery is below the lower threshold, start the engine and charge the battery via the generator until the SOC of the battery reaches an upper threshold; and upon the battery reaching the upper threshold, stop the engine.

At least one embodiment relates to a hybrid light tower, including: a housing defining an enclosure; an engine arranged within the enclosure; a mast; a generator configured to be driven by the engine and arranged within the enclosure; a battery pack arranged within the enclosure and mounted on a mounting assembly that includes an outer frame and an internal exhaust chamber, wherein the outer frame includes an exhaust cutout and the battery pack includes a vent formed in a bottom surface thereon, wherein the vent is positioned over the exhaust cutout a flow path is provided through the exhaust cutout and into the internal exhaust chamber, wherein the mounting assembly includes an external vent formed in an external wall thereof adjacent to a top surface of the outer frame and in fluid communication with the internal exhaust chamber; a light assembly coupled to the mast and including a light; and a controller in communication with the battery pack, the engine, and the light assembly, wherein the controller is configured to operate in an engine mode where the generator supplies power to the light, a battery mode where the battery pack supplies power to the light, or a hybrid mode where the battery pack supplies power to the light and the generator selectively charges the battery pack.

At least one embodiment relates to a hybrid light tower, including: a housing defining an enclosure; an engine arranged within the enclosure and including a coolant circuit; a mast; a generator configured to be driven by the engine and arranged within the enclosure; a battery pack arranged within the enclosure; a fan arranged within the enclosure; a light assembly coupled to the mast and including a light; and a controller in communication with the battery pack, the engine, the fan, and the light assembly, wherein the controller is configured to control a speed of the fan based on a coolant temperature within the coolant circuit and control a direction of the fan based on a battery cell temperature within the battery pack.

At least one embodiment relates to a hybrid light tower, including: an engine; a mast; a generator configured to be driven by the engine; a battery pack; a light assembly coupled to the mast and including a light, wherein the light is configured to be powered by the battery pack or the generator; and a controller in communication with the battery pack, the engine, and the light assembly, wherein the controller is configured to operate in an engine mode where the generator supplies power to the light, a battery mode where the battery pack supplies power to the light, or a hybrid mode where the battery pack supplies power to the light, in the hybrid mode, the controller is configured to: monitor a state of charge (SOC) of the battery pack; monitor a battery cell temperature of the battery pack; determine if the battery cell temperature is below a first temperature threshold; if the battery cell temperature is below the first temperature threshold, adjust a low SOC threshold from a first value to a second value that is higher than the first value; determine if the SOC of the battery pack is below the low SOC threshold; if the SOC of the battery pack is below the lower SOC threshold, start the engine and charge the battery pack via the generator until the SOC of the battery pack reaches an upper threshold; and upon the battery pack reaching the upper threshold, stop the engine.

In some aspects, the present disclosure relates to a hybrid light tower, including: a housing; an engine mounted within the housing; a mast; a generator mounted within the housing and configured to be driven by the engine; a battery mounted within the housing and electrically coupled to the generator; a light assembly coupled to the mast and including a light, wherein the light is configured to be powered by the battery or the generator; and a controller in communication with the battery, the engine, and the light assembly, wherein the controller is configured to operate in a hybrid mode where the controller is configured to: monitor a cell voltage of the battery; determine if the cell voltage of the battery is below a charging threshold; upon determining that the cell voltage of the battery is below the charging threshold, start the engine and charge the battery in a constant current mode; while charging in the constant current mode, determine if the cell voltage is above a constant voltage threshold; and upon determining that the cell voltage is above a constant voltage threshold, charge the battery in a constant voltage mode.

In some aspects, the present disclosure relates to a hybrid light tower, including: a housing; an engine mounted within the housing; a mast; a generator mounted within the housing and configured to be driven by the engine; a battery mounted within the housing and electrically coupled to the generator; a light assembly coupled to the mast and including a light, wherein the light is configured to be powered by the battery or the generator; a control panel including a charging plug-in; a charger arranged within the housing and electrically coupled to the battery; an electrical switch electrically coupled between the charging plug-in and the charger; and a controller in communication with the battery, the engine, the electrical switch, and the light assembly, wherein the controller is configured to selectively switch between a battery mode and a hybrid mode, wherein the controller is configured to control the electrical switch so that: in the hybrid mode, the electrical switch is configured to prevent power transmission from the charging plug-in to the charger; and in the battery mode, the electrical switch is configured to allow power transmission from the charging plug-in to the charger.

In some aspects, the present disclosure relates to a hybrid light tower, including: a housing defining an enclosure; an engine arranged within the enclosure; a mast; a generator configured to be driven by the engine and arranged within the enclosure; a battery pack arranged within the enclosure and mounted on a mounting assembly that includes an outer frame and an internal exhaust chamber, wherein the outer frame includes an exhaust cutout and the battery pack includes a vent formed in a bottom surface thereon, wherein the vent is positioned over the exhaust cutout a flow path is provided through the exhaust cutout and into the internal exhaust chamber, wherein the mounting assembly includes an external vent formed in an external wall thereof adjacent to a top surface of the outer frame and in fluid communication with the internal exhaust chamber; a light assembly coupled to the mast and including a light; and a controller in communication with the battery pack, the engine, and the light assembly, wherein the controller is configured to operate in an engine mode where the generator supplies power to the light, a battery mode where the battery pack supplies power to the light, or a hybrid mode where the battery pack supplies power to the light and the generator selectively charges the battery pack.

This summary is illustrative only and is not intended to be in any way limiting. Other aspects, inventive features, and advantages of the devices or processes described herein will become apparent in the detailed description set forth herein, taken in conjunction with the accompanying figures, wherein like reference numerals refer to like elements.

### BRIEF DESCRIPTION OF THE FIGURES

The disclosure will become more fully understood from the following detailed description, taken in conjunction with the accompanying figures, wherein like reference numerals refer to like elements, in which:

FIG. 1 is a perspective view of a light tower, according to an exemplary embodiment;

FIG. 2 is a rear view of the light tower of FIG. 1;

FIG. 3 is a front view of the light tower of FIG. 1;

FIG. 4 is a left side view of the light tower of FIG. 1;

FIG. 5 is a right side view of the light tower of FIG. 1;

FIG. 6. is a top view of the light tower of FIG. 1;

FIG. 7 is a bottom view of the light tower of FIG. 1;

FIG. 8 is a control panel of the light tower of FIG. 1;

FIG. 9 shows a user interface of the control panel of FIG. 8;

FIG. 10 shows a user interface of the control panel of FIG. 8;

FIG. 11 shows a user interface of the control panel of FIG. 8;

FIG. 12 shows a user interface of the control panel of FIG. 8;

FIG. 13 shows a user interface of the control panel of FIG. 8;

FIG. 14 shows a user interface of the control panel of FIG. 8;

FIG. 15 shows a user interface of the control panel of FIG. 8;

FIG. 16 shows a user interface of the control panel of FIG. 8;

FIG. 17 shows a user interface of the control panel of FIG. 8;

FIG. 18 is a block diagram of a control system of the light tower of FIG. 1;

FIG. 19 is a block diagram of the battery charging system of the control system of FIG. 18;

FIG. 20 is a flow chart of a method of controlling the light tower of FIG. 1 in a battery mode;

FIG. 21 is a flow chart of a method of controlling the light tower of FIG. 1 in an engine mode;

FIG. 22 is a flow chart of a method of controlling the light tower of FIG. 1 in a hybrid mode;

FIG. 23 is a flow chart of a method of controlling the light tower of FIG. 1;

FIG. 24 is a flow chart of a method of controlling the light tower of FIG. 1 in a recharge mode;

FIG. 25 is a front perspective view of a light tower, according to an exemplary embodiment;

FIG. 26 is a rear perspective view of the light tower of FIG. 25;

FIG. 27 is side perspective view of the light tower of FIG. 25;

FIG. 28 is a perspective view of an enclosure of the light tower of FIG. 25;

FIG. 29 is a perspective view of an enclosure of the light tower of FIG. 25;

FIG. 30 is a perspective view of an enclosure of the light tower of FIG. 25;

FIG. 31 is a perspective view of a battery assembly of the light tower of FIG. 25;

FIG. 32 is a cross-sectional view of the battery assembly FIG. 31;

FIG. 33 is a perspective view of a mounting assembly of the battery assembly of

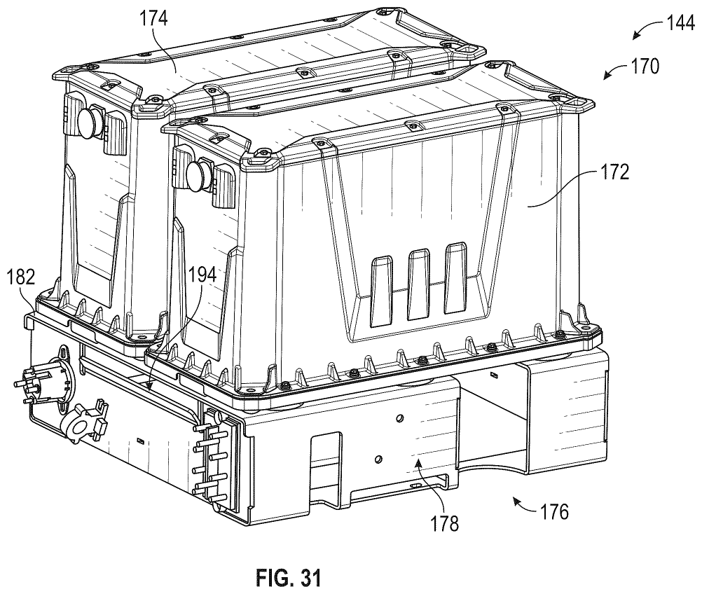

FIG. 31, with an outer mounting box being transparent;

FIG. 34 is a cross-sectional view of the battery assembly FIG. 31;

FIG. 35 is a cross-sectional view of the battery assembly FIG. 31;

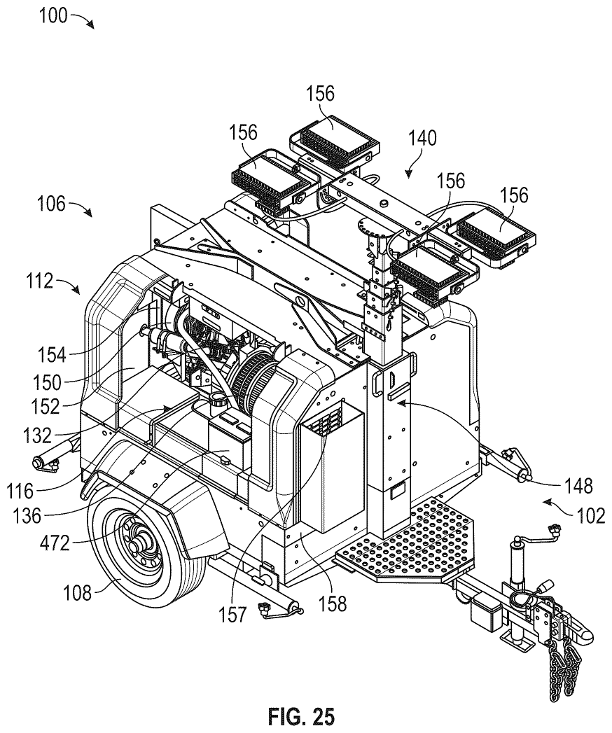

FIG. 36 is a perspective view of a control panel of the light tower of FIG. 25;

FIG. 37 is a front view of a CAN panel of the control panel of FIG. 36;

FIG. 38 is a front view of the control panel of the light tower of FIG. 25;

FIG. 39 is a block diagram of a control system of the light tower of FIG. 25;

FIGS. 40-58 show various screens on a user interface of the control panel of FIGS. 36 and 38;

FIG. 59 is a perspective view of a battery assembly of the light tower of FIG. 25 including an upper flange;

FIG. 60 is a cross-sectional view of the battery assembly FIG. 59;

FIG. 61 is a perspective view of a mounting assembly of the battery assembly of FIG. 59, with an outer mounting box being transparent;

FIG. 62 is a cross-sectional view of the battery assembly FIG. 59;

FIG. 63 is a cross-sectional view of the battery assembly FIG. 59;

FIG. 64 is a perspective view of a frame and housing of the light tower of FIG. 25 including stabilizing brackets;

FIG. 65 is a perspective view of the frame and housing of FIG. 64 with the battery packs installed;

FIG. 66 is a perspective view of the enclosure of the light tower of FIG. 25 including the stabilizing brackets;

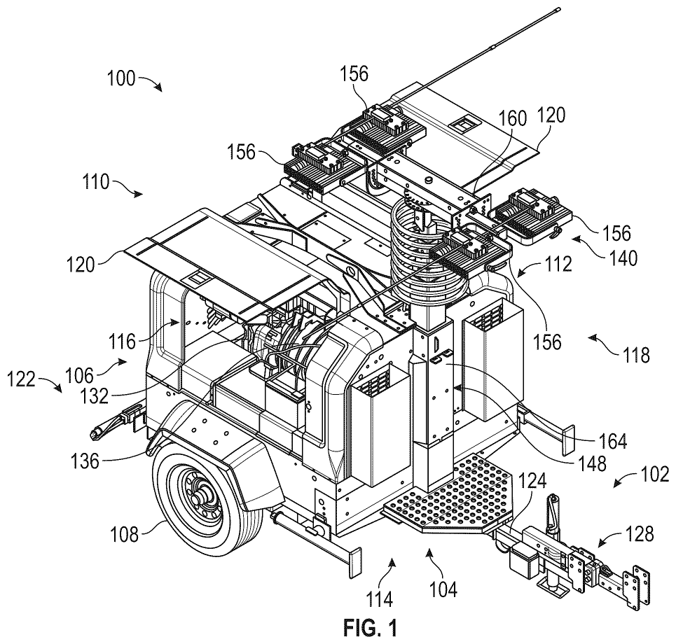

FIG. 67 is a schematic illustration of the light tower of FIG. 1 or FIG. 25 including an electrical switch between a charging plug-in and a charger;

FIG. 68 is a flowchart outlining the steps for controlling a light tower in a hybrid mode;

FIG. 69 is a flowchart outlining the steps for controlling a light tower in a constant voltage charging mode, during the hybrid mode of FIG. 68;

FIG. 70 is a schematic illustration of the light tower of FIG. 1 or FIG. 25 including battery docks to support battery packs to be charged by a charger; and

FIG. 71 is a schematic illustration of the light tower of FIG. 1 or FIG. 25 including battery docks to support battery packs to be charged by a dedicated charger.

### DETAILED DESCRIPTION

Before turning to the figures, which illustrate certain exemplary embodiments in detail, it should be understood that the present disclosure is not limited to the details or methodology set forth in the description or illustrated in the figures. It should also be understood that the terminology used herein is for the purpose of description only and should not be regarded as limiting.

Referring to the FIGURES generally, the various exemplary embodiments disclosed herein relate to systems, apparatuses, and methods for a hybrid lighting system, or a plug-in hybrid lighting system. The lighting system includes a light tower having a base, an engine coupled to the base and configured to drive a generator, a battery pack coupled to the base, a mast extending from the base, one or more lights coupled to the mast a one or more wheels coupled to the base, and a control system coupled to the base. The battery pack is electrically coupled to both a charger and the generator, and includes a one or more lithium-ion battery cells that are configured to provide power to the lighting system.

The control system includes a controller operably coupled to the engine, the battery pack, and the lights. The control system is further operably coupled to an engine controller, a battery management system (BMS), and a control panel. The control panel includes a user interface, a power outlet, and a charging plug-in. A user may interact with the control panel to provide a user input and control an operational status of the light tower. In general, the engine, the generator, the battery pack, and the control of these components defines a hybrid power system and is used to supply electrical power to the lights. The hybrid power system provides several different operational modes including battery mode, hybrid mode, engine mode, and recharge mode. The incorporation of the hybrid power system enables the lighting system to have longer runtimes, for example, when compared to engine-only and battery-only lighting systems.

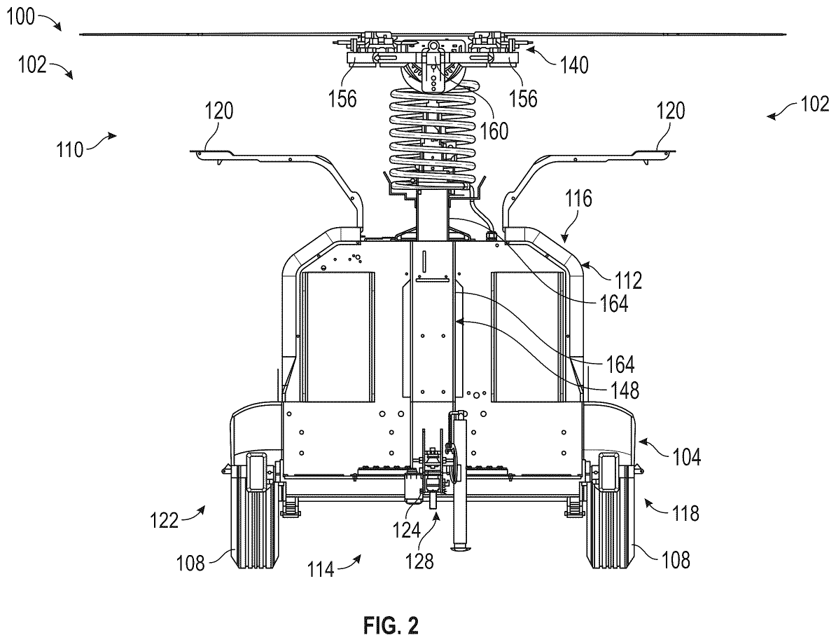

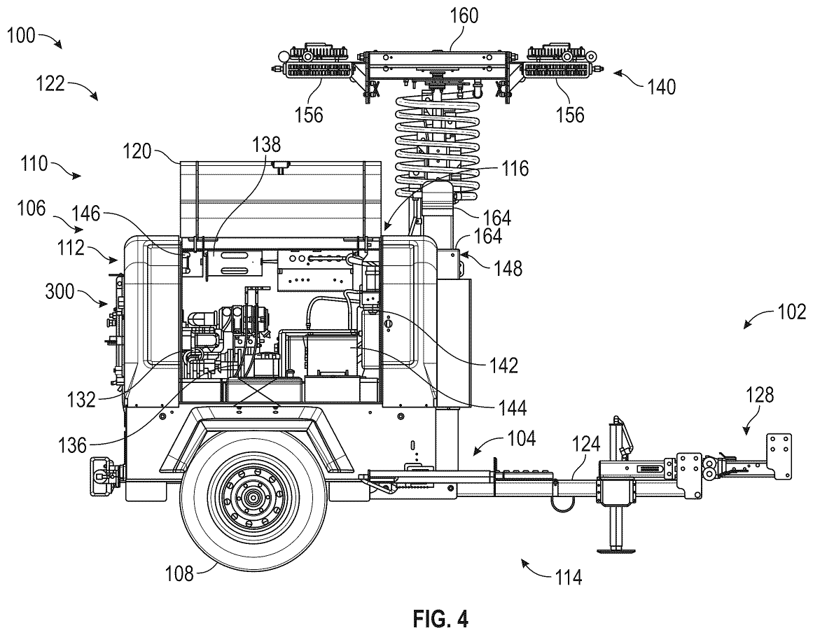

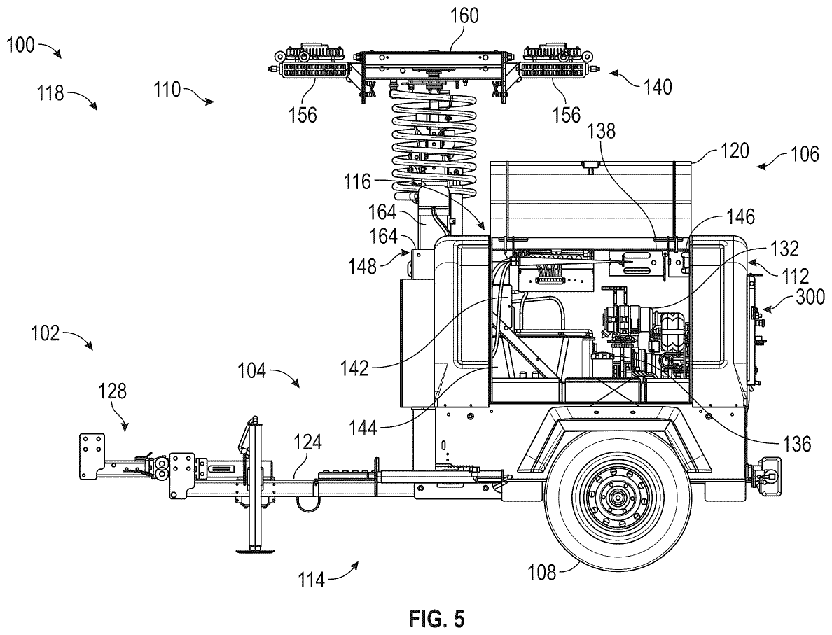

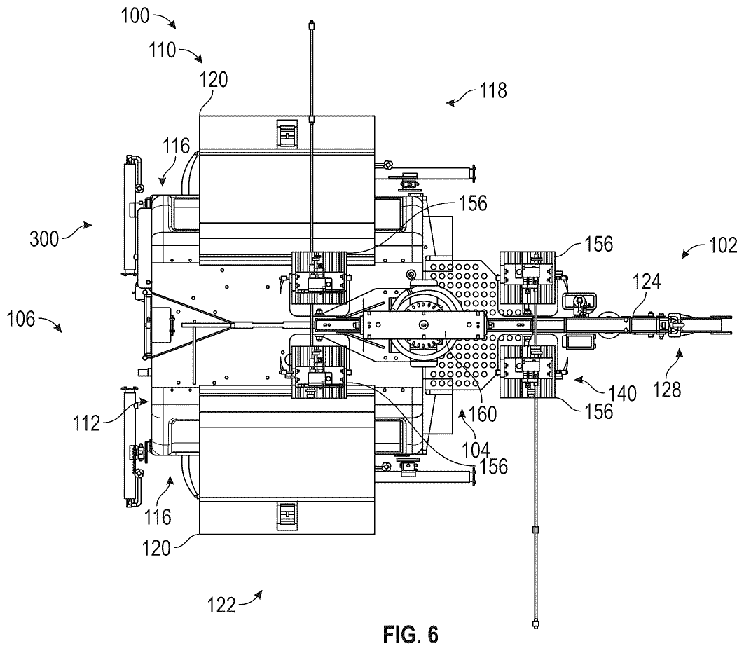

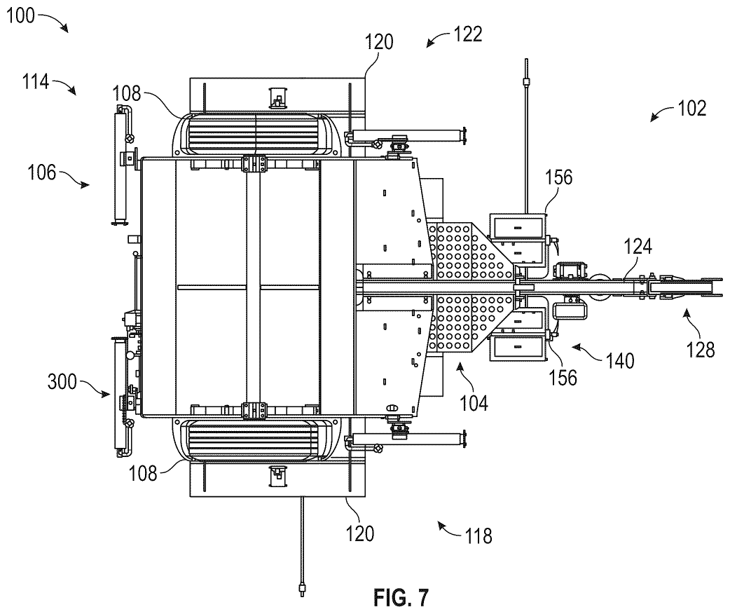

Referring now to FIGS. 1-7, a portable lighting tower, hybrid lighting tower, a plug-in hybrid light tower, towable lighting tower, or lighting tower, shown as light tower 100 is shown, according to an exemplary embodiment. The light tower 100 includes a first or front portion 102, a second or rear portion 106, a third or top portion 110, a fourth or bottom portion 114, a first lateral or right portion 118, and a second lateral or left portion 122. The light tower 100 includes a chassis or base, shown as a frame 104, one or more tractive elements, shown as wheels 108, and a housing 112.

According to an exemplary embodiment, the frame 104 is positioned along the bottom portion 114 and defines a longitudinal axis extending from the front portion 102 to the rear portion 106 of the light tower 100. The frame 104 further includes an arm (e.g., a rail, a tongue, etc.), shown as frame arm 124, extending outward (e.g., in a direction opposite the housing 112) from the frame 104. The longitudinal axis may be generally aligned with the frame arm 124 of the frame 104. The frame arm 124, may be detachedly coupled to a hitch (e.g., a tongue), shown as a hitch assembly 128, which is positioned along the longitudinal axis defined by the frame 104. In some embodiments, the hitch assembly 128 receives a hitch, ball, joint, etc., to allow a user to selectively reposition the light tower 100. The wheels 108 are coupled to the frame 104 and lift the frame 104 off of the ground so that the light tower 100 is repositionable and movable. In the illustrated embodiments, the wheels 108 are positioned opposite each other on the right portion 118 and the left portion 122 and coaxially aligned along an axle. By way of example, the light tower 100 may be lowered onto or aligned with a hitch, where the user may then exert a push or pull force onto the light tower 100 to move the light tower 100 in a desired direction (e.g., via a vehicle, via a motored device, via a user, etc.).

The housing 112 is supported by the frame 104 of the light tower 100. The housing 112 defines a chamber, housing, or enclosure 116 and includes one or more panels, shown as panels 120 disposed along the right portion 118 and the left portion 122. The panels 120 are pivotably coupled to the housing 112 such that when the one or more panels 120 move upward (e.g., towards the top portion 110 of the light tower 100), the enclosure 116 is accessible to a user. In some embodiments, the panels 120 are symmetrical about the longitudinal axis.

The light tower 100 further includes a hybrid power system. The hybrid power system includes a first driver, shown as engine 132, positioned within the enclosure 116 of the housing 112. The engine 132 may receive fuel (e.g., gasoline, diesel, etc.) from a fuel tank and combusts the fuel to generate rotational mechanical energy. The fuel tank may include a fuel level sensor positioned within the fuel tank, where the fuel level sensor provides a fuel status (e.g., level of the fuel in the fuel tank, etc.). The rotational mechanical energy from the engine 132 may then be supplied to one or more components (e.g., a generator, one or more lights, one or more electric motors, one or more controllers, etc.) of the light tower 100.

The hybrid power train further includes a permanent magnet generator, shown as generator 136, coupled to the engine 132. The generator 136 is positioned within the enclosure 116 of the housing 112. The generator 136 may further be driven by the engine 132, where the generator 136 converts the rotational mechanical energy generated by the engine 132 into electrical energy. In some embodiments, the engine 132 and the generator 136 are formed as a single component (e.g., a motor/generator) and supported on the frame 104. The electrical energy from the generator 136 may then be supplied to one or more components of the light tower 100. By way of example, the generator 136 generates direct current (DC) power that may be supplied directly to an inverter 138 or a battery pack, shown as battery 144. In some embodiments, the generator 136 generates alternating current (AC) power that is rectified by a rectifier 142 to DC power and provided to a light assembly 140 and/or to recharge the battery 144, depending on the operating mode of the light tower 100. In some embodiments, the inverter 138 converts DC power from the battery 144 to alternating current (AC) power that may then be supplied to a power outlet (e.g., power outlet 340) to power a device connected to the light tower 100. The battery 144 includes a battery management system (BMS) 145 and is also coupled to a charger 146 that recharges the battery 144 when the battery is below a maximum state of charge (SOC). The charger 146 converts AC power from a plug-in, shore power source (e.g., charging plug-in 344) to DC power (e.g., via the rectifier 142 or a dedicated rectifier within the charger 146) to charge the battery 144.

The battery 144, the engine 132, the generator 136, the inverter 138, the rectifier 142, and the charger 146 are enclosed within the enclosure 116 of the housing 112 and supported on the frame 104. In some embodiments, the battery 144 is removably coupled to the frame 104 to allow the battery 144 to be changed with another battery 144 in case the battery 144 needs to be charged, no longer usable, or needs to be changed for various other reasons. In some embodiments, the battery 144 is removably coupled to the housing 112 through one or more fasteners (e.g., a bolt, screw, or other fastening agent). In some embodiments, the engine 132, the generator 136, the battery 144, the inverter 138, the rectifier 142, or the charger 146 are at least partially enclosed within the housing 112.

The frame 104 is coupled to an extendable or adjustable mast, shown as mast 148. The mast 148 is moveable between a storage configuration and a deployed configuration. The mast 148 includes one or more light assemblies, shown as light assembly 140 arranged at a top end (e.g., an end opposite of the end which the mast 148 is coupled to the frame 104) of the mast 148. Each light assembly 140 includes one or more lights 156 and a moveable or adjustable frame, shown as frame 160. By way of example, the one or more lights 156 may include one or more light emitting diodes (LED). In some embodiments, the one or more lights 156 may be incandescent lights. In general, the frame 160 allows the one or more lights 156 to be moved and adjusted. For example, the frame 160 may allow each one of the one or more lights 156 to be swiveled and/or rotated about the mast 148, and moved in any direction (e.g., within the range of the frame 160). In some embodiments, the frame 160 allows the one or more lights 156 to be tilted, turned, and/or moved. Tilting and turning the one or more lights 156 allows a user to position a beam of light as desired. In some embodiments, the mast 148 and/or the frame 160 may be mechanically controlled by one or more electric motors for tilting, turning, raising, or lowering the one or more lights 156. The one or more electric motors may be controlled by a controller discussed further herein (e.g., in response to a user input and/or automatic controls based on other gathered signals from the light tower 100).

In some embodiments, the mast 148 may be lowered and raised between the storage configuration and the deployed configuration. The mast 148 may include multiple mast sections or members 164 (e.g., a top member, one or more middle members, a bottom member) that telescope to raise and lower the mast 148. For example, when lowering the mast 148, the top member 164 lowers inside of the one or more middle members 164, all of which lower inside of the bottom member 164, and so on. In this way, the bottom member 164 may have the largest diameter, and the top member 164 may have the smallest diameter.

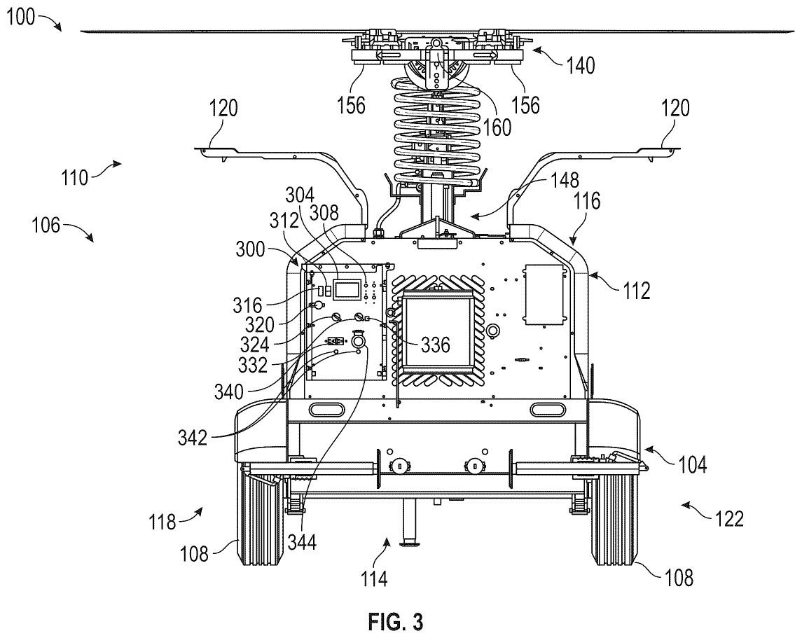

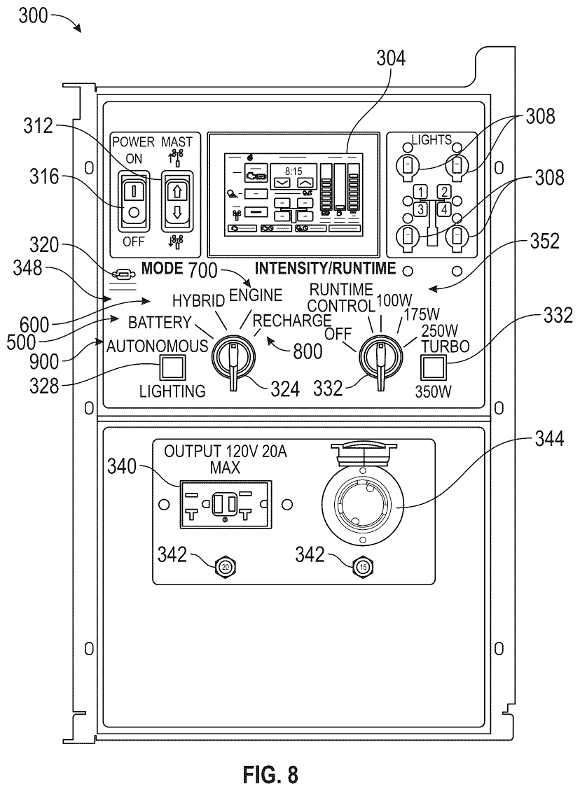

Referring specifically to FIGS. 3 and 8, the light tower 100 includes a control panel 300 arranged along the rear portion 106 of the light tower 100 and coupled to the housing 112. The control panel 300 is includes knobs, switches, dials, and buttons so that the user may more easily and conveniently interact with the control panel 300 using gloves. Any feature (e.g., knob, switch, dial, breaker, button, etc.) of the control panel 300 described herein may be configured alternatively as one or more knobs, switches, dials, breakers, or buttons. The control panel 300 includes one or more displays, shown as a user interface 304, one or more light switches or breakers, shown as a light switch 308, one or more mast switches, shown as a mast switch 312, and a power switch 316. In the illustrated embodiment, the light switch 308, the mast switch 312, and the power switch 316 are laterally spaced from the user interface 304. The light switch 308 includes manual light breakers (e.g., on/off switches) to turn each of the one or more lights 156 on or off manually. The mast switch 312 can be moved by a user to raise or lower the mast 148. The power switch 316 can be moved by the user to turn the light tower 100 on and off.

The control panel 300 further includes a port, shown as a diagnostic port 320, a mode dial 324, a mode button 328, an intensity-runtime dial, shown as a performance dial 332, and a performance button 336. In some embodiments, the diagnostic port 320 is a USB-B port configured to connect a device (e.g., a sensor, a meter, a laptop, etc.) to retrieve diagnostics information of the light tower 100. In the illustrated embodiment, the diagnostic port 320, the mode dial 324, the mode button 328, the performance dial 332, and the performance button 336 are spaced below the user interface 304, the light switch 308, the mast switch 312, and the power switch. Additionally, the mode dial 324 is laterally spaced from the performance dial 332. The mode button 328 is located proximately to the mode dial 324, and the performance button 336 is located relative to the performance dial 332, relative to one another.

The control panel 300 further includes one or more power outlets or ports, shown as a power outlet 340, a charging plug-in 344, and one or more breakers, shown as breakers 342. In the illustrated embodiment, the power outlet 340 is laterally spaced from the charging plug-in 344, both of which are located below the mode dial 324 and the performance dial 332, respectively. In some embodiments, the power outlet 340 includes one or more 20 A, 120V outlets and one or more USB ports to provide power to an external device plugged in to the power outlet 340 by the user. In some embodiments, the charging plug-in 344 is electrically connected to the on-board battery charger 146 and configured to receive power from an external power source (e.g., wall power, shore power, etc.). The charging plug-in 344 allows for the light tower 100 to receive power (e.g., be plugged-in, or be a plug-in hybrid light tower) while the light tower 100 is turned on (in some operating modes) or turned off. Further, the breaker 342 is laterally spaced from breaker 342, both of which are located below the power outlet 340 and the charging plug-in 344.

Referring to FIG. 8, the user may interact with the mode dial 324 and the mode button 328 to place the light tower 100 in one or more modes 348. The one or more modes 348 includes a battery mode 500, a hybrid mode 600, an engine mode 700, a recharge mode 800, and an autonomous lighting mode, shown as autonomous mode 900. The mode dial 324 can be rotated by the user to place the light tower 100 in the battery mode 500, the hybrid mode 600, the engine mode 700, or the recharge mode 800. The mode button 328 can be pressed by the user to place the light tower 100 in the autonomous mode 900. In alternative embodiments, the autonomous mode 900 may be configured with the mode dial 324 and/or the battery mode 500, the hybrid mode 600, the engine mode 700, or the recharge mode 800 may be initiated similarly to the mode button 328.

Referring still to FIG. 8, the user may interact with the performance dial 332 and the performance button 336 to specify one or more performance parameters 352 of the light tower 100. The one or more performance parameters 352 include an intensity (e.g., 100 W, 175 W, 250 W, or 350 W), a runtime (e.g., a runtime control), or neither specified parameter (e.g., off). The performance dial 332 can be rotated by the user to specify the intensity or the runtime of the one or more lights 156. The performance button 336 can be pressed by the user to specify a higher intensity (e.g., TURBO, 350 KW) for the one or more lights 156 than the intensity of the performance dial 332. In alternative embodiments, the higher intensity may be configured with the performance dial 332 and/or the intensity or the runtime of the one or more lights 156 may be initiated similarly to the performance button 336.

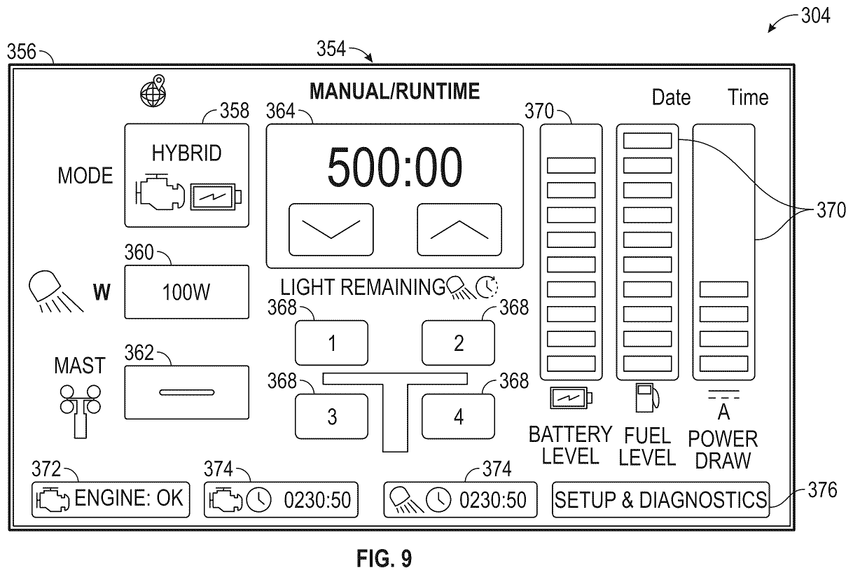

Referring to FIGS. 9-17, the user interface 304 generally includes visual indicators, statuses, and settings based on inputs from the user. In some embodiments, the user interface 304 is one or more touch screens, graphical user interfaces, or other types of input devices that allow the user to input information and display information to a user. The user interface 304 may provide one or more screens that are indicated by a screen title or label 354 at the top of user interface 304. The label 354 will change based on a selection from the user engaging with the user interface 304 and may reflect information indicative of one or more modes 348 or one or more performance parameters 352.

Referring to FIG. 9, the user interface 304 includes an overview display 356. The overview display 356 provides the user information that includes a mode status 358, an intensity status 360, a mast status 362, a runtime button or indicator 364, one or more light statuses or buttons, shown as light indicator 368, a one or more level indicators 370, an engine status or button 372, one or more runtime timers 374, and a setup and diagnostics button, shown as settings button 376. In alternative embodiments, the arrangement and positioning of the overview display 356 may vary from the illustrated embodiment.

The mode status 358 indicates the light tower 100 is in the one or more modes 348. The mode status 358 changes based on a selection from the user by the mode dial 324 or the mode button 328. The intensity status 360 indicates the one or more performance parameters 352 of the light tower 100. The intensity status 360 changes based on a selection from the user by the performance dial 332 or the performance button 336 (e.g., 100 W, 175 W, 250 W, TURBO, etc.). The mast status 362 indicates information of the mast 148. The mast status 362 changes based on a selection from the user by the mast switch 312. The runtime indicator 364 includes one or more buttons that the user may touch to increase or decrease the runtime. The runtime indicator 364 provides the user information indicative of one or more of a total runtime, a desired runtime, an estimated runtime, or a current runtime. The light indicator 368 includes information indicative of a status of the one or more lights 156. In some embodiments, the light indicator 368 responds to the user engaging with the light switch 308 and provides the status of the one or more lights 156 (e.g., the light indicator 368 lights up if the corresponding light is on and the light indicator 368 becomes dark if the corresponding light is off). In alternative embodiments, the light indicator 368 includes one or more buttons that correspond to the one or more lights 156. The user may touch the one or more buttons to turn change the status of the one or more lights 156. The one or more buttons also provide an indication of the status of the one or more lights 156 (e.g., the button lights up if the corresponding light is on and the button becomes dark if the corresponding light is off). The one or more level indicators 370 include information indicative of a level or status of the battery 144 (e.g., a battery level, a start batt voltage, a coolant temperature, the engine 132 (e.g., a fuel level, an engine rpm), or a power draw of the light tower 100. The engine status button 372 provides the user a visual indication of the engine status (e.g., “OK,” “OFF,” etc.). The user may touch the engine status button 372 to learn more about the engine status, and the user interface 304 will respond by changing from the current display to an engine status display 378. The one or more runtime timers 374 include information indicative of a runtime the engine 132 has been on or running or a runtime the one or more lights 156 have been on or running. In some embodiments, the one or more runtime timers 374 include a runtime of the battery 144, the generator 136, or another component of the light tower 100. The settings button 376 allows the user to navigate from the overview display 356 or the current display to a setup and diagnostics display, shown as settings display 380.

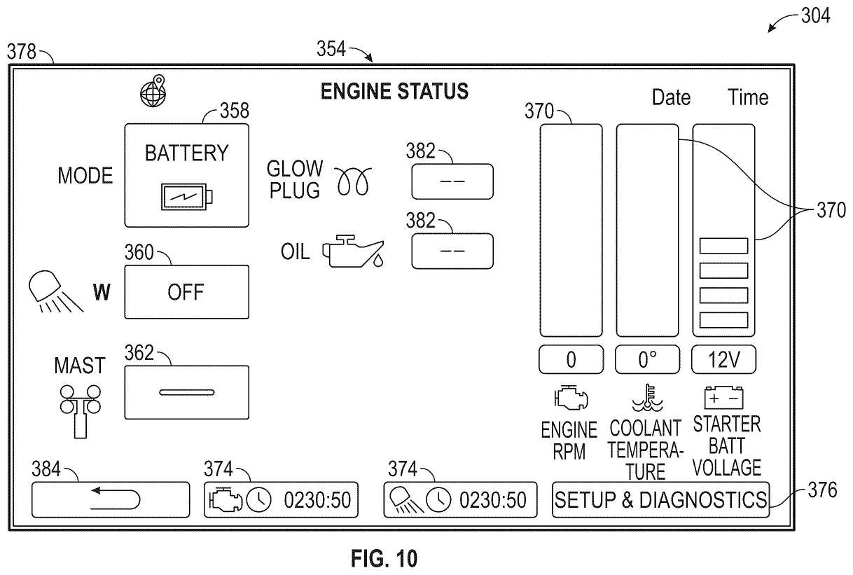

Referring to FIG. 10, the user interface 304 further includes the engine status display 378. In some embodiments, the engine status display 378 includes substantially similar features (e.g., the mode status 358, the one or more level indicators 370, etc.) as the overview display 356. The engine status display 378 further includes one or more engine parameters 382 (e.g., glow plug, oil, temperature, rpm, etc.), and a return button 384 that allows the user to return to a previous display.

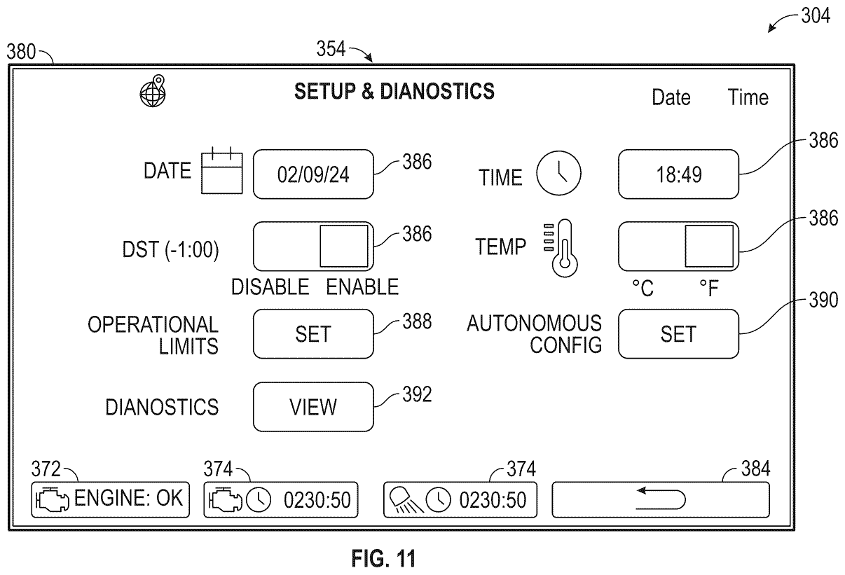

Referring to FIG. 11, the user interface 304 further includes the settings display 380. In some embodiments, the settings display 380 includes substantially similar features (e.g., the engine status button 372, the one or more runtime timers 374, the return button 384, etc.) as the overview display 356 and the engine status display 378. The settings display further includes one or more setting inputs 386, an operational limits button 388, an autonomous configuration button 390, and a diagnostics button 392. The user can press one or more setting inputs 386 to enter in information regarding a date, time, daylight savings time, temperature units, etc. The user can press the operational limits button 388 to set the operational limits of the light tower 100, and the user interface 304 will respond by changing from the settings display 380 to an operational limits display 394. The user can press the autonomous configuration button 390 to configure settings of the autonomous mode 900, and the user interface 304 will respond by changing from the settings display 380 to an autonomous configuration display 396. The user can press the diagnostics button 392 to view diagnostic information of the light tower 100.

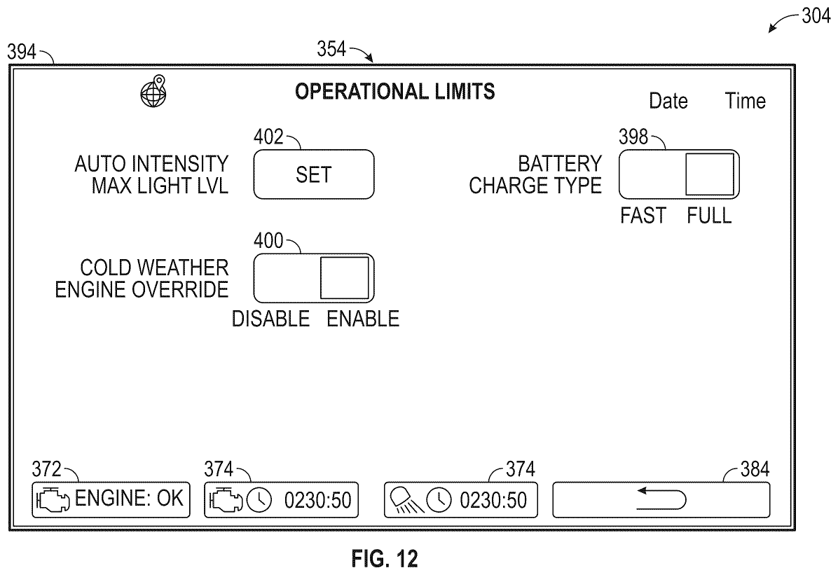

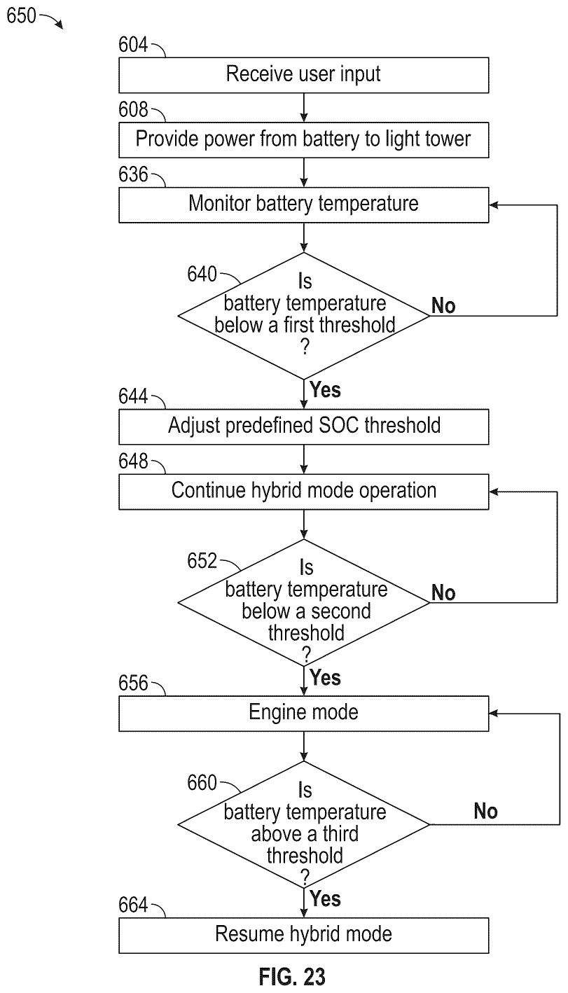

Referring to FIG. 12, the user interface 304 further includes the operational limits display 394. In some embodiments, the operational limits display 394 includes substantially similar features as the overview display 356, the engine status display 378, or the settings display 380. The operational limits display 394 further includes a battery charge type button 398, a cold weather engine override button, shown as override button 400, and an intensity settings button 402. The battery charge type button 398 allows the user to select a battery charge type (e.g., fast or full). In some embodiments, responsive to the user selecting a fast battery charge type, the battery 144 is charged to 80% SOC to minimize the amount of time the engine 132 is on in hybrid mode 600. In some embodiments, responsive to the user selecting a full battery charge type, the battery 144 is charged to 95% SOC. The override button 400 allows the user to enable or disable an engine override in which the engine 132 overrides the battery 144 when the battery 144 temperature is below a certain threshold as described herein (e.g., see FIG. 23). The intensity settings button 402 can be pressed by the user to set a maximum intensity, and the user interface 304 will respond by changing from the operational limits display 394 to an intensity settings display 404.

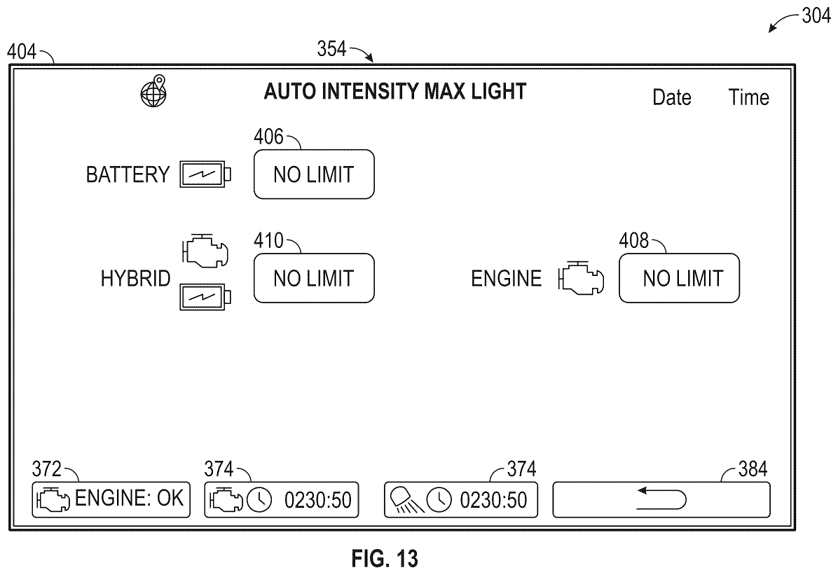

Referring to FIG. 13, the user interface 304 includes the intensity settings display 404. In some embodiments, the operational limits display 394 includes substantially similar features as the overview display 356, the engine status display 378, the settings display 380, or the operational limits display 394. The intensity settings display 404 includes a battery intensity setting 406, an engine intensity setting 408, and a hybrid intensity setting 410. The battery intensity setting 406 can be pressed by the user to set a maximum intensity of the one or more lights 156 for the battery 144 in battery mode 500. The engine intensity setting 408 can be pressed by the user to set a maximum intensity of the one or more lights 156 for the engine 132 in engine mode 700. The hybrid intensity setting 410 can be pressed by the user to set a maximum intensity of the one or more lights 156 for the battery 144 and engine 132 in hybrid mode 600.

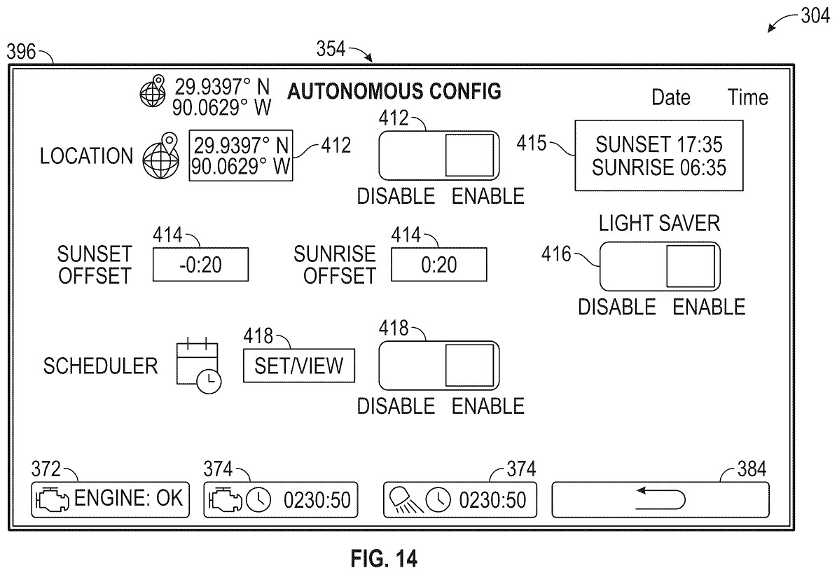

Referring to FIG. 14, the user interface includes the autonomous configuration display 396. The autonomous configuration display 396 includes a location button 412, one or more offset buttons 414, a tracker, shown as calculation indicator 415, a light saver button 416, and a scheduler button 418, which are used to input one or more parameters of the autonomous mode 900 of the light tower 100. The user can press the location button 412 to input a coordinates indicative of a location of the light tower 100 and disable or enable coordinates of the location of the light tower 100. In some embodiments, the coordinates provided are used to determine one or more calculated times that correlate to a sunrise or sunset (e.g., on or off). The one or more offset buttons 414 allow the user to enter an offset value corresponding to a time before or after sunset or sunrise. In some embodiments, the one or more offset buttons 414 allow for adjustments for the one or more lights 156 to turn on and off relative to actual calculated times. The calculation indicator 415 provides an estimated sunrise time and an estimated sunset time based on inputs to the one or more setting inputs (e.g., date and time) and the location button 412. The light saver button 416 may be pressed to disable or enable a light saver. In some embodiments, enabling the light saver transitions the light intensity up and down to a target value (e.g., a maximum lighting value) during on or off events based on the calculated times and the offset values. The scheduler button 418 allows the user to set and/or view a schedule of the light tower 100 and navigates the user to a scheduler display 420.

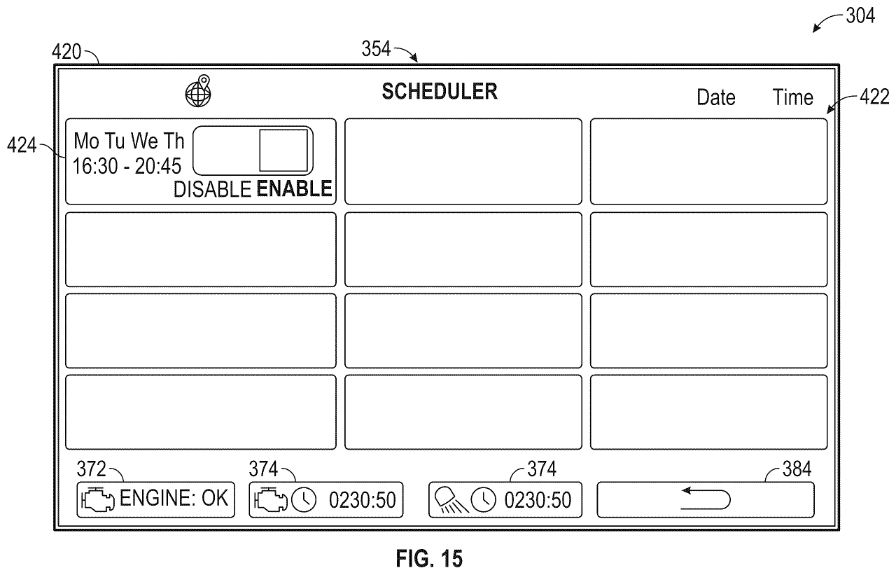

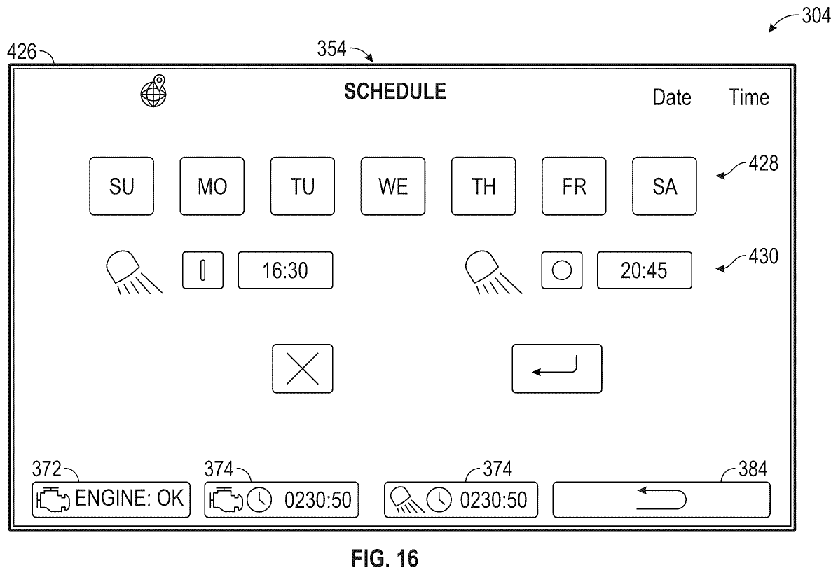

Referring to FIG. 15, the user interface 304 includes the scheduler display 420. The scheduler display 420 includes one or more schedule slots 422 for a user to select. In the illustrated embodiment, the one or more schedule slots 422 have an event 424. The event 424 displays the dates and times of when the light tower 100 is scheduled to turn on. The user can interact with the event 424 to disable or enable the event 424 or edit the event 424 on the schedule display 426, shown in FIG. 16. The schedule display 426 includes day buttons 428 each of which can be pressed to include or remove the respective day from the schedule, and time buttons 430 for a user to indicate a time for the light tower 100 to turn on and a time for the light tower 100 to turn off.

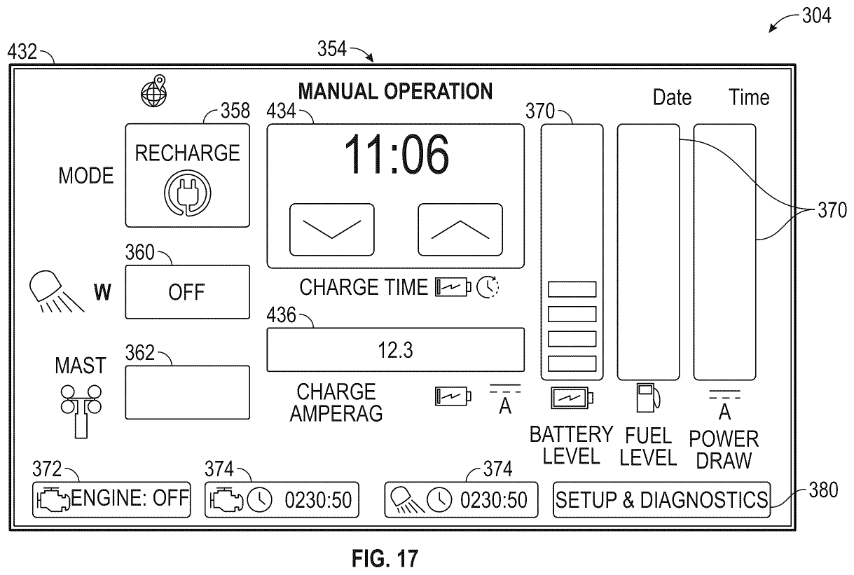

Referring to FIG. 17, the user interface 304 includes a recharge display 432. The recharge display 432 includes substantially similar features as the overview display 356. The recharge display 432 further includes a charge time indicator 434 and a charge amperage indicator 436. The charge time indicator 434 provides the remaining charge time of the battery 144. The charge amperage indicator 436 provides the amperage at which the battery 144 is being charged.

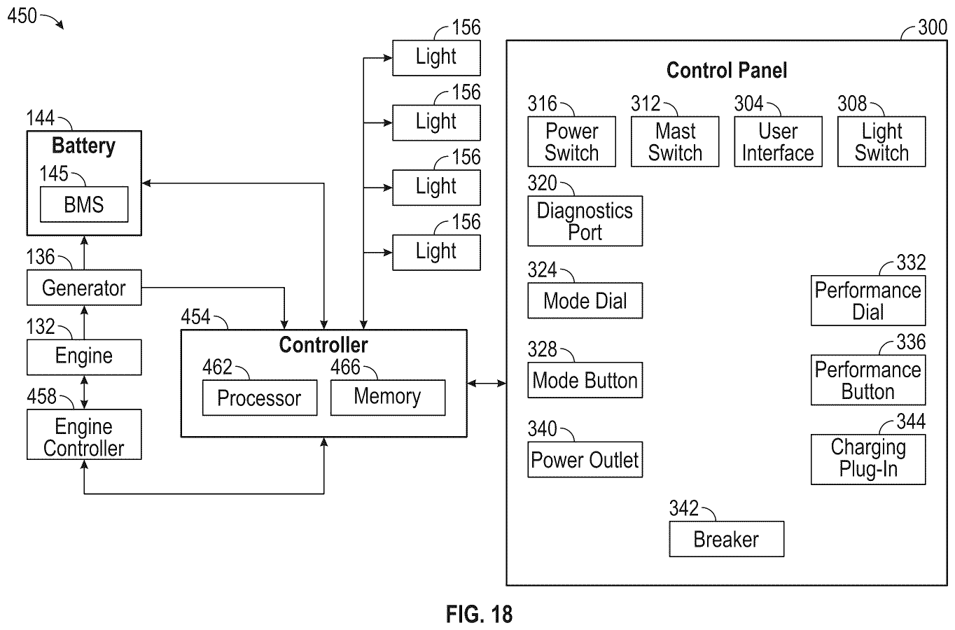

Referring to FIG. 18, the light tower 100 includes a control system 450. In general, the connections and arrows between blocks in the control system 450 of FIG. 18 may refer to an electrical coupling, a communicative coupling, an operable coupling, a physical coupling, and/or a combination of one or more these couplings. In some embodiments, some or all of the connections may represent a Controller Area Network (CAN). In some embodiments, the control system 450 The control system 450 includes the engine 132, the generator 136, the battery 144, the BMS 145, the one or more lights 156, the control panel 300, a controller 454, and an engine controller 458.

The controller 454 includes a processing circuit including a processor 462 and memory 466. The processing circuit can be communicably connected to a communications interface such that the processing circuit and the various components thereof can send and receive data via the communications interface. The processor 462 can be implemented as a general purpose processor, an application specific integrated circuit (“ASIC”), one or more field programmable gate arrays (“FPGAs”), a group of processing components, or other suitable electronic processing components.

The memory 466 (e.g., memory, memory unit, storage device, etc.) can include one or more devices (e.g., RAM, ROM, Flash memory, hard disk storage, etc.) for storing data and/or computer code for completing or facilitating the various processes, layers and modules described in the present application. The memory 466 can be or include volatile memory or non-volatile memory. The memory 466 can include database components, object code components, script components, or any other type of information structure for supporting the various activities and information structures described in the present application. According to some embodiments, the memory 466 is communicably connected to the processor 462 via the processing circuit and includes computer code for executing (e.g., by the processing circuit and/or the processor 462) one or more processes described herein.

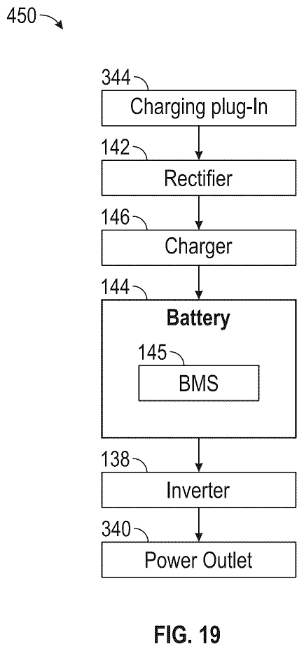

The battery 144 may be charged by the generator 136, which is powered from the engine 132. The BMS 145 may be operably coupled to the controller 454, where the BMS 145 may send and receive control signals. Specifically, the BMS 145 may be configured to monitor a status, utilization, etc., of the battery 144 and to provide an output command to the controller 454 indicating a status of the battery 144. According to an exemplary embodiment, the controller 454 may send a command to the engine controller 458 for the engine 132 to output a specific power to the generator 136 based on feedback to the controller 454. As shown in FIG. 19, the battery 144 may be charged by the charger 146, which outputs DC power from the rectifier 142. The rectifier 142 converts the AC power supplied by the charging plug-in 344 to DC power to supply to the charger 146 for the battery 144. In some embodiments, the rectifier 142 may supply DC power to the one or more lights 156, the control panel 300, the controller 454, or other components of the light tower 100. The inverter 138 may receive DC power supplied by the battery 144 and convert the DC power to AC power to supply to the power outlet 340.

The engine 132 is operably coupled to the engine controller 458. The engine controller 458 may further be operably coupled to the controller 454, where the engine controller 458 may send and receive control signals. Specifically, the engine controller 458 may be configured to monitor a status, operating characteristics, utilization, etc., of the engine 132 and to provide an output command to the engine 132 based on feedback from the controller 454. According to an exemplary embodiment, the controller 454 may provide a command to the engine controller 458 for a desired engine output (e.g., output speed, output power, and/or output torque, etc.). In some embodiments, the controller 454 may determine speed of the engine 132 that will meet a runtime requirement.

The controller 454 is configured to control the power to the one or more lights 156. In some embodiments, the amount of light produced by each of the one or more lights 156 is dimmable based on the power received by each of the one or more lights 156. Accordingly, a user may directly adjust the power supplied to the one or more lights 156 based on a variety of factors including required runtime, needed light, and/or time of day. As described further herein, the one or more lights 156 may also be adjusted (e.g., by controller 454) without manual control.

In some embodiments, the controller 454 is configured to receive a user input from the control panel 300 and is communicably and electrically coupled to the user interface 304, the light switch 308, the mast switch 312, the power switch 316, the diagnostic port 320, the mode dial 324, the mode button 328, the performance dial 332, the performance button 336, the power outlet 340, the charging plug-in 344, and the breaker 342. The power switch 316 is communicably and/or electrically coupled to the controller 454 and/or the battery 144 to control power output to the light tower 100. In one embodiment, the power switch 316, is an on/off switch. When in an “on” position, components of the control system 450 (e.g., the one or more lights 156, the controller 454, etc.) receive power from the battery 144 (or another battery on the light tower 100). When in an “off” position, the components of the control system 450 (e.g., the one or more lights 156, the controller 454, etc.) do not receive power from the battery 144.

In some embodiments, the controller 454 receives the user input from the performance dial 332 and/or the performance button 336 of the control panel 300. The user input from the performance dial 332 and/or the performance button 336 includes one or more performance parameters 352, which include the intensity or the runtime. Responsive to receiving the user input that indicates the intensity (e.g., 100 W, 175 W, 250 W, 350 W, etc.) or the runtime (e.g., the runtime control), the controller 454 will calculate an amount of stored energy using a fuel level and a fuel economy, which is determined through a calculation and/or a look-up table based on one or more modes 348, a current drawing from the rectifier 142, and an engine speed. The stored energy represents an available energy output from the battery 144 and the engine 132, so the controller 454 can determine a minimum and a maximum runtime available based on a minimum and a maximum intensity available for each of the one or more lights 156. The controller 454 uses the calculation to adjust the runtime or the intensity up or down in the battery mode 500, the hybrid mode 600, the engine mode 700, and the autonomous mode 900. For the user input that indicates the intensity, a calculated runtime will appear on the runtime indicator 364, the intensity status 360 will display a maximum total light level available for a selected intensity, and the light indicator 368 will display which of the one or more lights 156 are operating at the selected intensity. For the user input that indicates the runtime, a selected runtime will appear on the runtime indicator 364, the intensity status 360 will display the maximum total light level available for a calculated intensity, and the light indicator 368 will display which of the one or more lights 156 are operating the calculated intensity.

In some embodiments, the controller 454 receives the user input from the user interface 304 of the control panel 300. The user may configure and enable the autonomous mode 900 through the settings display 380, the operational limits display 394, the autonomous configuration display 396, the intensity settings display 404, the scheduler display 420, and the schedule display 426. The autonomous mode 900 may run in conjunction with or simultaneously to the battery mode 500, the hybrid mode 600, and the engine mode 700 of the light tower 100. The controller 454 receives a date, a time, and a location from the control panel 300 and uses a solar calculator (e.g., NOAA Solar Calculator) to calculate the estimated sunrise time and the estimated sunset time to be displayed on the user interface 304 of the control panel 300, so the user can input an offset to either the estimated sunrise time or the estimated sunset time to allow for adjustments of the estimated sunrise time and the estimated sunset time relative to an actual sunrise time and an actual sunset time.

Responsive to the light saver being enabled in autonomous mode 900, the controller 454 will control the one or more lights 156 to transition the intensity up and down to a set target maximum lighting value in response to one or more events (e.g., indicated by the event 424 inputted one or more schedule slots 422). The controller 454 uses the estimated sunrise time, the estimated sunset time, and the respective offset to determine the transition of the intensity. In some embodiments, the transition of the one or more lights 156 from off to a maximum intensity or a maximum intensity to off is based on the offset of the estimated sunrise time and the offset of the estimated sunset time. In such embodiments, the controller 454 transitions the one or more lights 156 at the estimated sunset time so the one or more lights 156 are at the maximum intensity by the offset of the estimated sunset time. Further, in such embodiments, the controller 454 transitions the one or more lights 156 at the estimated sunrise time so the one or more lights 156 are completely off by the offset of the estimated sunrise time. In some embodiments, the transition of the one or more lights 156 from off to a maximum intensity or a maximum intensity to off is based on the estimated sunrise time and the offset of the estimated sunset time. In such embodiments, the controller 454 begins the transition of the one or more lights 156 without the offset to the estimated sunset time so that the one or more lights 156 are at the maximum intensity by the actual sunset time. Further, in such embodiments, the controller 454 begins the transition of the one or more lights 156 without the offset to the estimated sunrise time so that the one or more lights 156 are completely off by the actual sunrise time.

Responsive to the scheduler being enabled in autonomous mode 900, the controller 454 will turn the light tower 100 on and off based on a date and a time provided in the scheduler display 420 and the schedule display 426. The user inputs the event 424 into the one or more schedule slots 422. The user can specify one or more days, an on time, and an off time. The controller 454 will power the one or more lights 156 based on the events 424 inputted into the one or more schedule slots 422. In some embodiments, one or more of the scheduler, the light saver, and the location may be enabled for the autonomous mode 900.

In some embodiments, the controller 454 receives the user input from the mode dial 324 and/or the mode button 328 of the control panel 300. The user input from the mode dial 324 and/or the mode button 328 includes one or more modes 348, which include the battery mode 500, the hybrid mode 600, the engine mode 700, the recharge mode 800, and the autonomous mode 900.

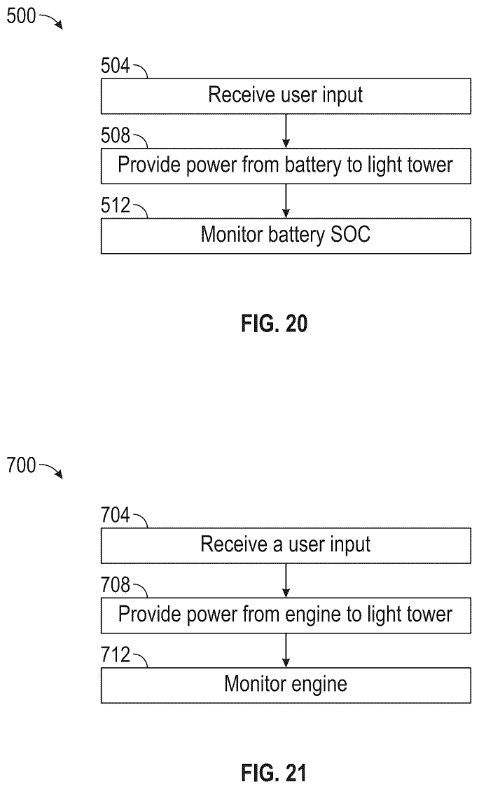

FIG. 20 shows a method of controlling the light tower 100 in the battery mode 500. At process 504, the controller 454 receives a user input. In some embodiments, the user input is provided by the control panel 300. The user input may include a selection from the control panel 300 that includes at least the battery mode 500 from the mode dial 324. The battery mode 500 limits the power supply so that power is only supplied by the battery 144 to the light assembly 140. In some embodiments, the battery 144 may receive power from the charging plug-in 344, while in the battery mode. In such embodiments, the battery 144 is charged by the charger 146 while the battery 144 is supplying power to the light assembly 140. At process 508, the battery 144 provides power to the light tower 100. The battery 144 supplies power to the one or more lights 156, the control panel 300, the power outlet 340, and the other components of the light tower 100. At process 512, the controller 454 monitors the SOC of the battery 144. In some embodiments, the BMS 145 monitors the SOC of the battery 144 and communicates with the controller 454. In some embodiments, the BMS 145 receives feedback using amperage and temperature to determine the runtime and communicates with the controller 454. In some embodiments, the controller 454 determines the runtime of the light tower 100 using the SOC of the battery 144 and one or more performance parameters 352 and provides the runtime to the user interface 304 of the control panel 300. In some embodiments, the controller 454 defines a low SOC threshold for the battery 144 that is based on a minimum battery cell temperature (e.g., if the minimum battery cell temperature is below a temperature threshold, the low SOC threshold is a first value, and if the minimum battery cell temperature is above the temperature threshold, the low SOC threshold is a second value that is lower than the first value). Once the controller 454 detects that the battery 144 reaches the low SOC threshold, the controller 454 turns off the lights 156 and the controller 454 waits for a user interaction to occur (e.g., change to recharge mode). In some embodiments, the controller 454 monitors a voltage of the battery 144 and/or a minimum battery cell voltage within the battery 144 to determine when to turn off the lights 156 and require charging of the battery 144.

FIG. 21 shows a method of controlling the light tower 100 in the engine mode 700. At process 704, the controller 454 receives a user input. In some embodiments, the user input is provided by the control panel 300. In some embodiments, the controller 454 provides the user input to the engine controller 458. The user input may include a selection from the control panel 300 that includes at least the engine mode 700 from the mode dial 324. The engine mode 700 supplies power to the light assembly 140 from the engine 132 and generator 136. At process 708, the engine 132 and the generator 136 provide power to the light tower 100. In some embodiments, the engine controller 458 varies the engine speed and the engine load based on the user input (e.g., the runtime, the intensity, etc.) for the one or more lights 156. At process 712, the controller 454 monitors the engine 132. The engine controller 458 monitors the fuel level, the speed, the load, etc., of the engine 132 and communicates with the controller 454. In some embodiments, the controller 454 determines the runtime of the light tower 100 using the fuel level and one or more performance parameters 352 and provides the runtime to the user interface 304 of the control panel 300.

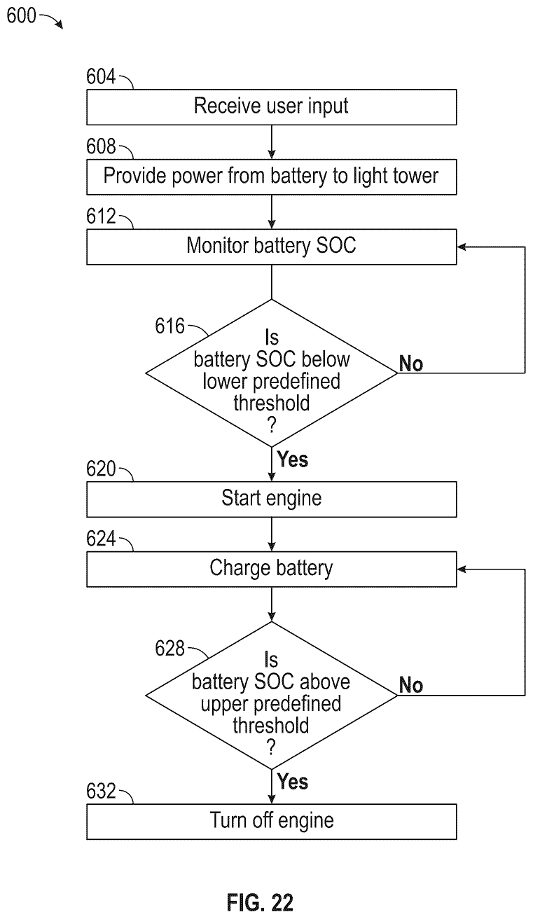

FIG. 22 shows a method of controlling the light tower 100 in the hybrid mode 600. At process 604, the controller receives a user input. In some embodiments, the user input is provided by the control panel 300. The user input may include a selection from the control panel 300 that includes at least the hybrid mode 600 from the mode dial 324. In some embodiments, the controller 454 provides the user input to the engine controller 458 and the BMS 145. At process 608, the battery 144 provides power to the light tower 100. In some embodiments, the battery 144 provides power to the light tower 100 based on the user input, similarly to the battery mode 500. At process 612, the controller 454 monitors the SOC of the battery 144. In some embodiments, the BMS 145 monitors the SOC of the battery 144 and communicates with the controller 454. At process 616, the controller 454 determines if the SOC of the battery 144 is below a first or lower predefined threshold. Responsive to the controller 454 determining the battery 144 is above the lower predefined threshold, the controller 454 continues to monitor the SOC of battery 144. Responsive to the controller 454 determining the SOC of the battery 144 is below the lower predefined threshold, at process 620, the controller 454 starts the engine 132. In some embodiments, the engine 132 is started with a 12V lead acid starting system or starter battery.

At process 624, the battery 144 is charged. In some embodiments, controller 454 communicates with the engine controller 458 so the engine 132 drives the generator 136 to charge the battery 144. The engine 132 supplies power to the battery 144, the one or more lights 156, and the other components of the light tower 100. The engine controller 458 and the controller 454 communicate with the engine 132 to maximize the charge rate of the battery 144 to an upper SOC. At process 628, the controller 454 determines if the SOC of the battery 144 is above a second or upper predefined threshold. Responsive to the controller 454 determining the battery 144 is below the upper predefined threshold, the controller 454 continues to charge the battery 144 with the engine 132 and the generator 136. Responsive to the controller 454 determining the battery 144 is above the upper predefined threshold, at process 632, the controller 454 turns off the engine 132, and the battery 144 continues to supply power to the light assembly 140 based on the user input as in process 608. In some embodiments, the voltage of the battery 144 and/or a minimum cell voltage of the battery 144 is used to control when the engine 132 starts and stops charging the battery 144.

FIG. 23 shows a battery temperature monitoring method or process 650 of the light tower 100. The method described in FIG. 23 may occur while the light tower 100 is operating in the battery mode 500 or in the hybrid mode 600. The override button 400 enables the method of FIG. 23 as described herein. Similar to the method described in FIG. 22, at process 604, the controller receives a user input. At process 608, the battery 144 provides power to the light tower 100. At process 636, the controller 454 monitors a temperature of the battery 144. In some embodiments, the BMS 145 monitors the temperature of the battery and communicates with the controller 454. At process 640, the controller 454 determines if the temperature of the battery 144 is below a first threshold (e.g., first temperature threshold, first predefined threshold). In some embodiments, the first threshold is approximately 40° F.

Responsive to the controller 454 determining the temperature of the battery 144 is above the first threshold, the controller 454 continues to monitor the temperature of the battery 144. Responsive to the controller 454 determining the temperature of the battery 144 is below the first threshold, at process 644, the controller 454 adjusts a predefined SOC or SOC threshold (e.g., updated SOC threshold). In some embodiments the predefined SOC threshold is adjusted based on the lower predefined threshold from the hybrid mode 600. In some embodiments, the controller 454 increases the predefined SOC threshold from a minimum SOC limit to an increased minimum SOC limit (e.g., 40%) to protect the battery 144. At process 648, the controller 454 continues in the battery mode 500 or the hybrid mode 600. In the illustrated mode, the controller 454 continues in the hybrid mode 600 at process 648. In some embodiments, the controller 454 continues in the battery mode 500 or the hybrid mode 600 using the predefined SOC threshold as the lower predefined threshold to charge the battery 144.

At process 652, the controller 454 determines if the temperature of the battery 144 is below a second threshold (e.g., second temperature threshold, second predefined threshold). Responsive to the controller 454 determining the temperature of the battery 144 is above the second threshold, the controller 454 continues in the hybrid mode 600. Responsive to the controller 454 determining the temperature of the battery 144 is below the second threshold, at process 656, the controller 454 switches to the engine mode 700.

At process 660, the controller 454 determines if the temperature of the battery 144 is below a third threshold (e.g., third temperature threshold, third predefined threshold). In some embodiments, the third threshold is greater than, less than, or equal to the first threshold. In some embodiments, the third threshold is greater than, less than, or equal to the second threshold. Responsive to the controller 454 determining the battery 144 is below the third threshold, the controller 454 continues in the engine mode 700. Responsive to the controller 454 determining the battery 144 is above the third threshold, at process 664, the controller 454 switches or resumes the hybrid mode 600 or the battery mode 500.

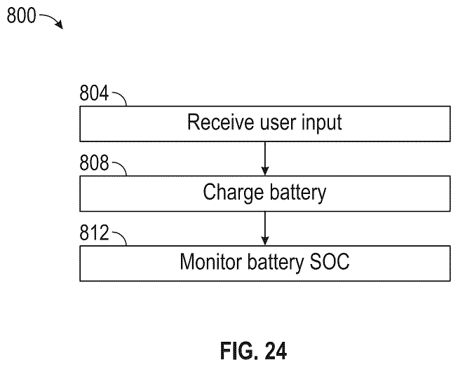

FIG. 24 shows a method of controlling the light tower 100 in the recharge mode 800. At process 804, the controller 454 receives a user input. In some embodiments, the user input is provided by the control panel 300. The user input may include a selection from the control panel 300 that includes at least the recharge mode 800 from the mode dial 324. The recharge mode 800 allows the battery 144 to return to a maximum SOC (e.g., full charge). At process 808, the battery 144 is charged. In some embodiments, the battery 144 may receive power from the charging plug-in 344 and is charged by the charger 146.

In some embodiments, the battery 144 is charged based on the battery charge type selected by the user using the battery charge type button 398. In some embodiments, responsive to the user selecting the fast battery charge type, the battery 144 is charged to 80% SOC to minimize the amount of time the engine 132 is on. In such embodiments, the battery 144 is charged only by a constant current, which draws more power and occurs faster. In some embodiments, responsive to the user selecting a full battery charge type, the battery 144 is charged to 95% SOC. In such embodiments, the battery 144 is charged by the constant current and a controlled voltage, which increases charging time. In some embodiments, the battery 144 is charged by a combination of constant current and constant voltage, as described herein.

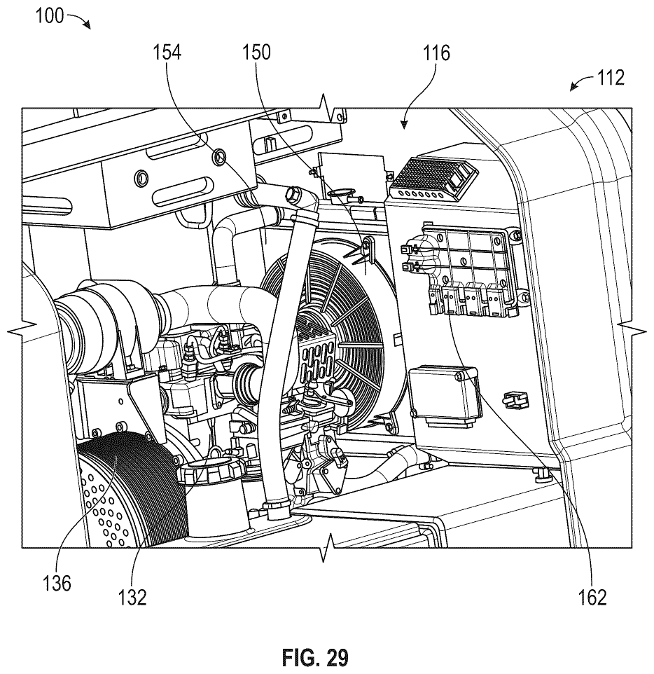

FIGS. 25-30 show an exemplary embodiment of the light tower 100 including a fan 150. In general, the light tower of FIGS. 25-30 is similar to the light tower 100 of FIGS. 1-18, with like features identified using the same reference numerals, except as described herein or as apparent from the figures. In the illustrated embodiment, the light tower 100 includes the fan 150 arranged internally within the enclosure 116. Specifically, the fan 150 is mounted on an internal surface of a rear wall 152 of the housing 112 adjacent to the rear portion 106. The fan 150 may be positioned adjacent or coupled to a radiator 154 of the engine 132 so that the fan 150 directs airflow over the radiator 154 to provide cooling to a coolant circuit of the engine 132.

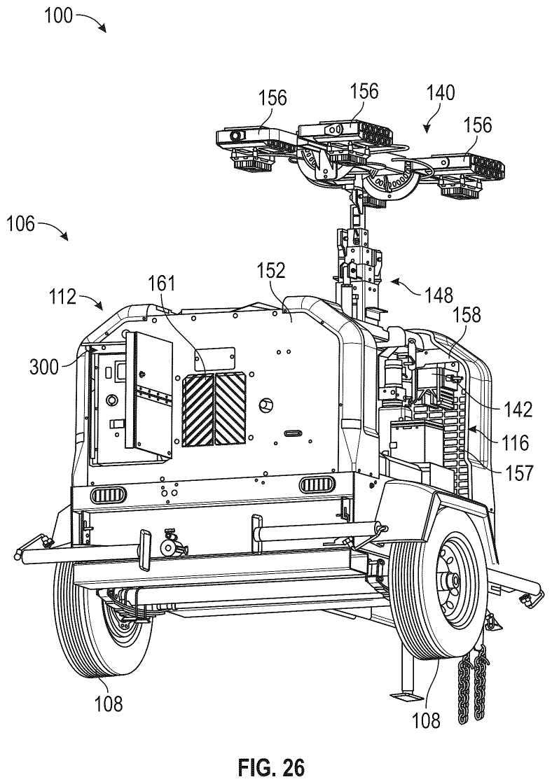

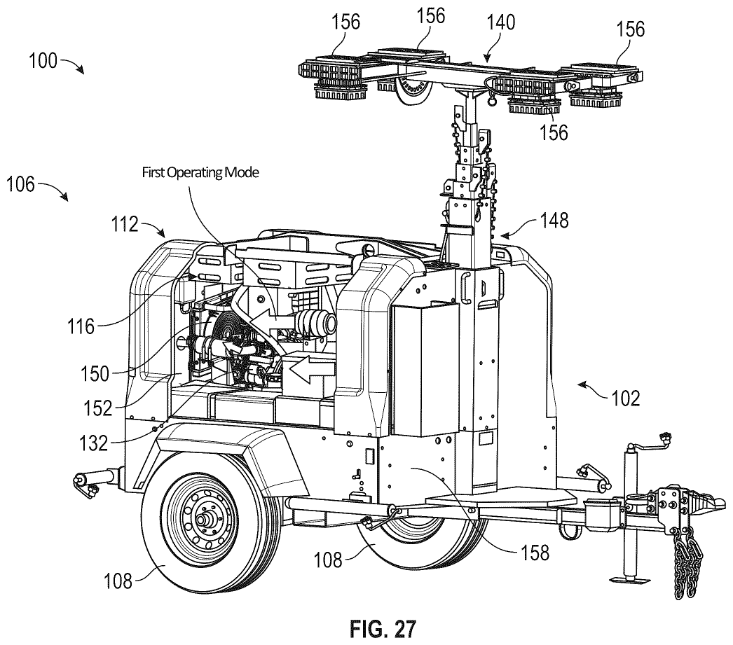

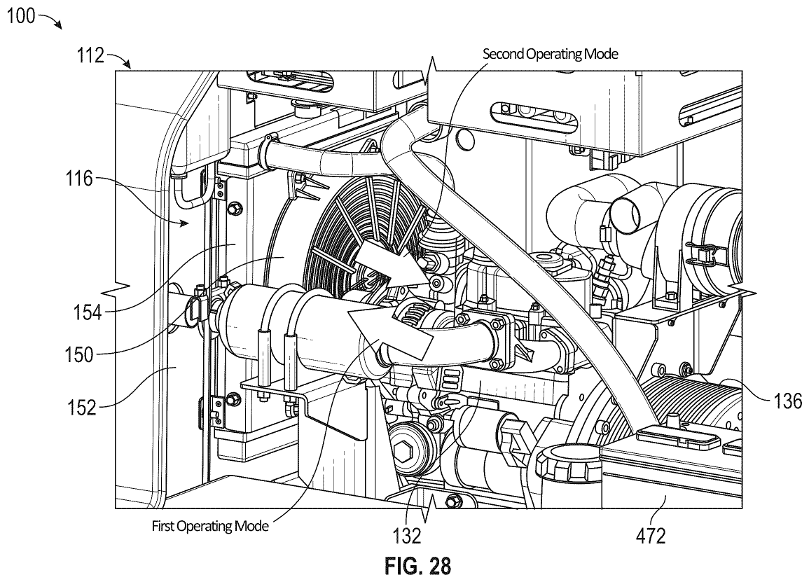

In some embodiments, the fan 150 is configured to operate in a first operating mode where the fan 150 rotates in a first direction, and a second operating mode where the fan 150 rotates in a second direction opposite to the first direction. In the first operating mode, the fan 150 may draw fresh air through a vent or perforated portion 157 of a front wall 158 in the housing 112 (see, e.g., the arrows in FIG. 25 indicating the direction of airflow). The air drawn in through the perforated portion 157 of the front wall 158 flows into the enclosure 116 and initially travels over the rectifier 142, which is coupled to an internal side of the front wall 158 (see, e.g., FIG. 26). By having the air initially flow over the rectifier 142, the rectifier 142 is provided with a maximum amount of cooling capacity available in the air flow and the cooling improves the efficiency of the rectifier 142. From the rectifier 142, the air flows over the engine 132, then reaches the fan 150 as indicated by the arrows in FIG. 27, and flows over the radiator 154, which provides cooling to the engine 132 and the coolant circuit thereof. After flowing through the radiator 154, the air exits the enclosure 116 and flow out of a vent or perforated portion 161 formed in the rear wall 152 (see, e.g., FIG. 26). In the second operating mode, the fan 150 reverses direction and draws air through the perforated portion 161 so that the air flows over the radiator 154 (see, e.g., FIG. 28). The heat from the radiator 154 warms the air, which can then be used to warm the enclosure 116 and the battery 144 therein during certain operating conditions, as will be described herein.

In some embodiments, the fan 150 is connected to a fan controller or power distribution module (PDM) 162 that controls the speed and direction of the fan 150, for example, based on pulse-width modulation (PWM). In some embodiments, the fan controller 162 is in communication with the controller 454 and the controller 454 is configured to control the speed and direction of the fan 150 based on a temperature of a battery cell within the battery 144 (e.g., communicated from the BMS 145 to the controller 454) and a coolant temperature within the coolant circuit of the engine 132 (e.g., communicated from the engine controller 458 to the controller 454).

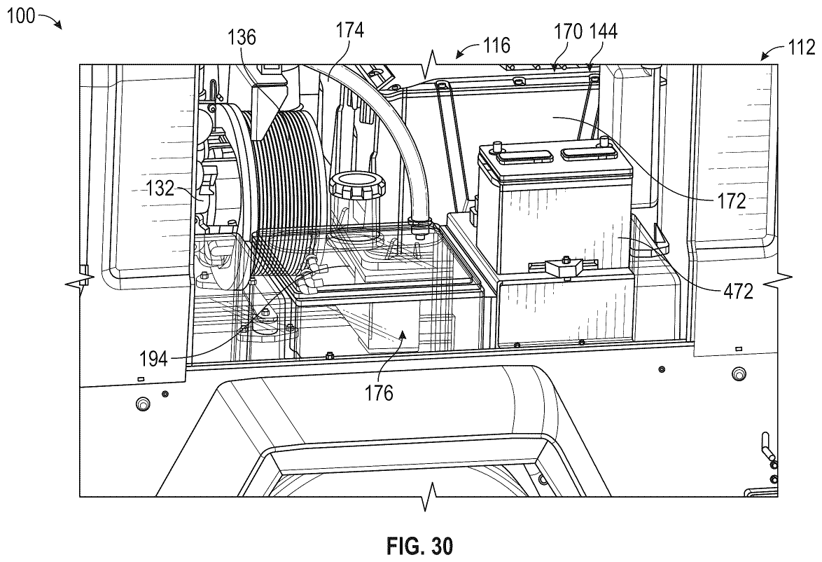

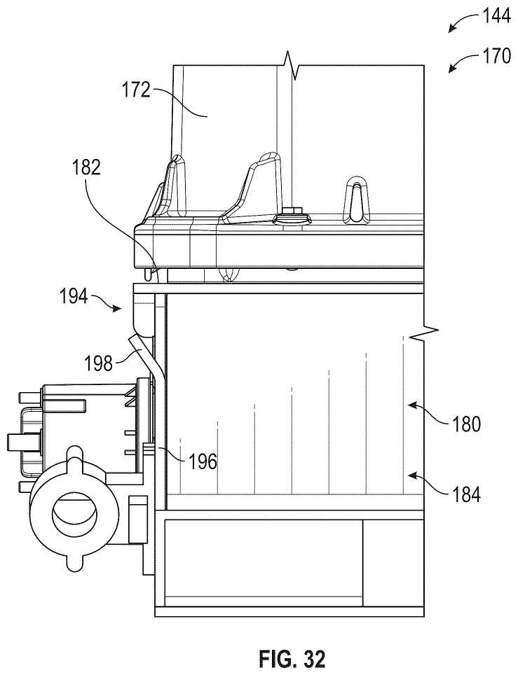

Turning to FIGS. 30-35, the battery 144 is included in a battery assembly 170 that is mounted within the enclosure 116. In the illustrated embodiment, the battery assembly 170 includes a first battery pack 172 and a second battery pack 174 (e.g., the battery 144 comprises the first battery pack 172 and the second battery pack 174 connected in parallel). In some embodiments, the battery 144 may include more or less than two battery packs. The first battery pack 172 and the second battery pack 174 are mounted and supported on a mounting assembly 176. The mounting assembly 176 includes an outer frame or box 178 upon which the first battery pack 172 and the second battery pack 174 are supported and an internal exhaust chamber or enclosure 180. For example, a bottom wall or surface of each of the first battery pack 172 and the second battery pack 174 is supported on an upper or top surface 182 of the outer frame 178. The top surface 182 of the outer frame 178 elevates the first battery pack 172 and the second battery pack 174 above a floor within the enclosure 116 of the housing 112, which creates space for the internal exhaust chamber 180 to be positioned between the top surface 182 and the floor of the housing 112.

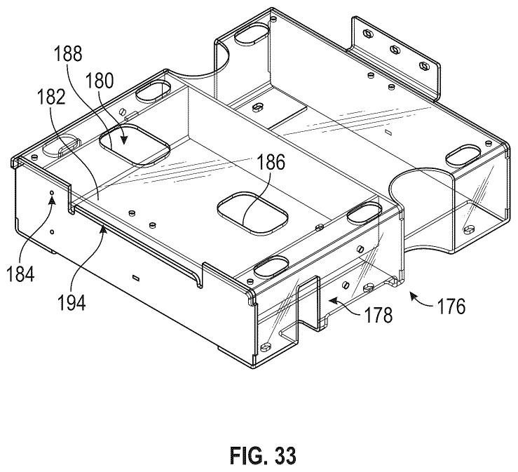

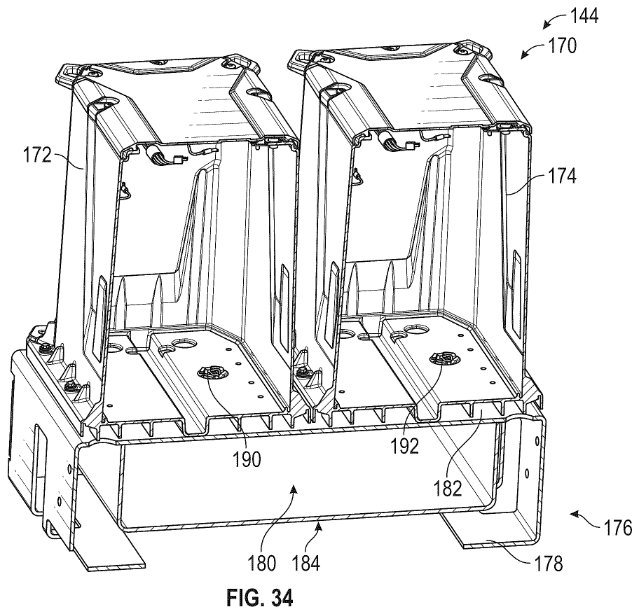

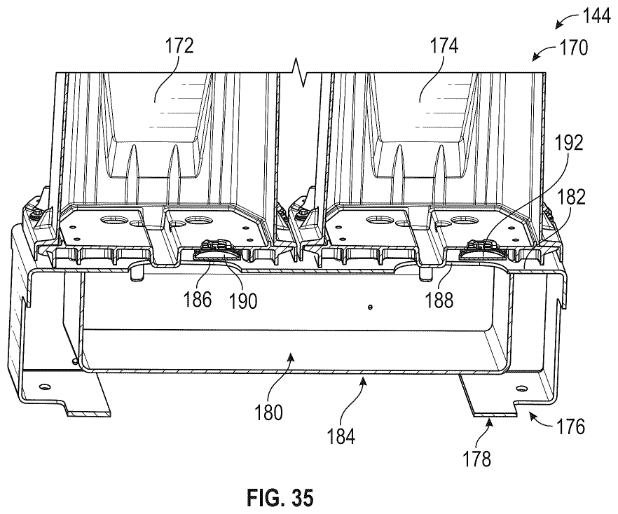

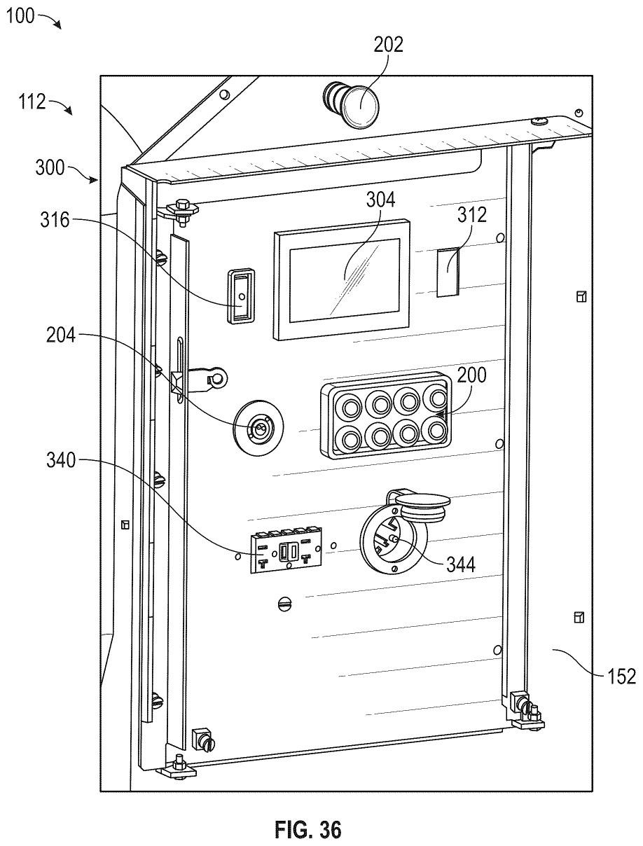

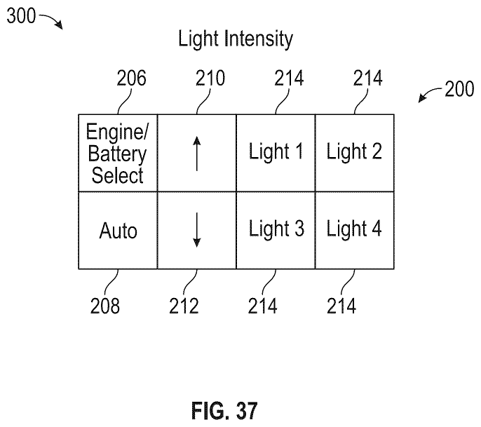

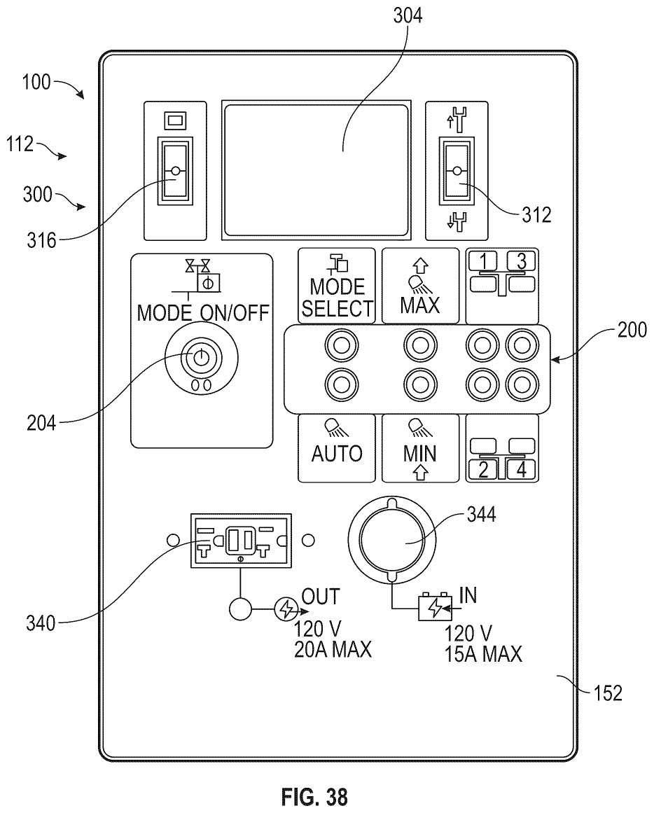

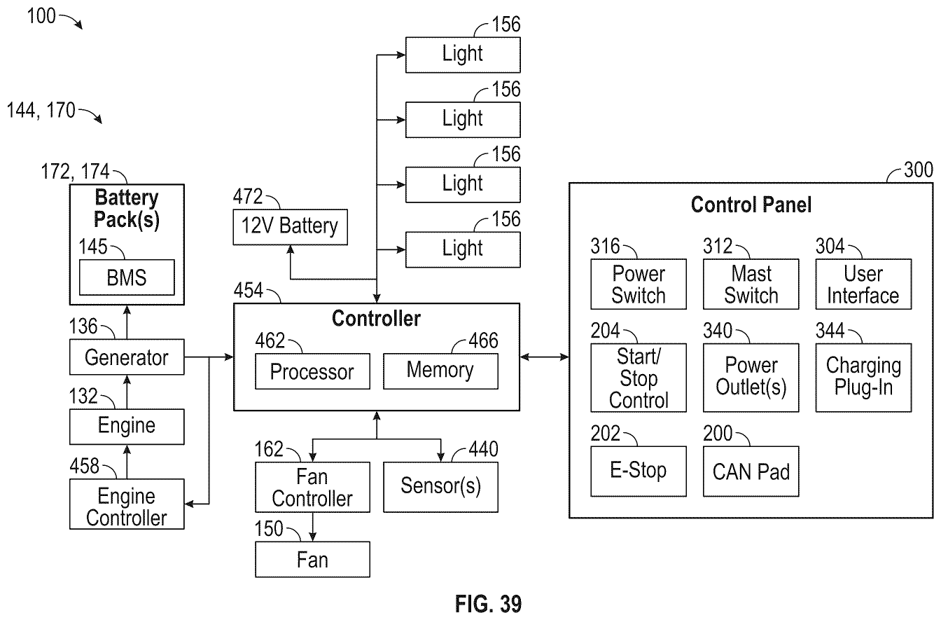

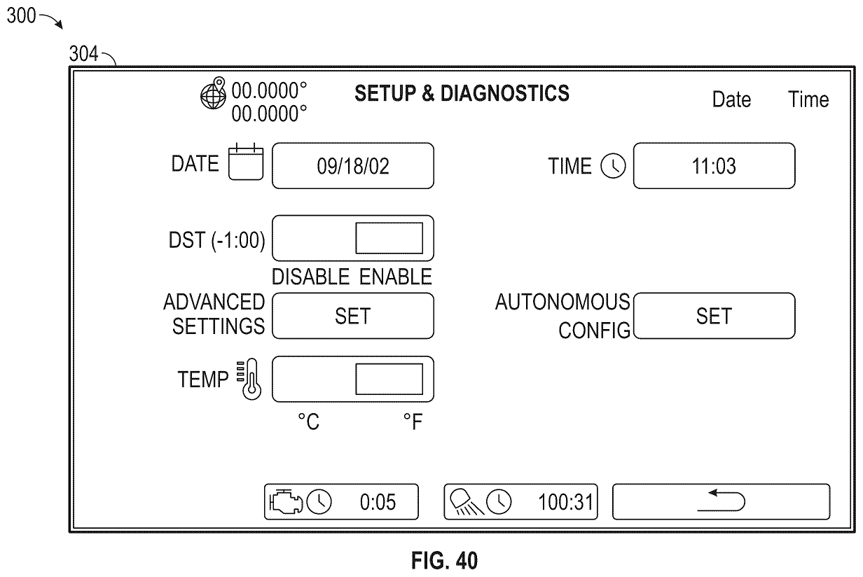

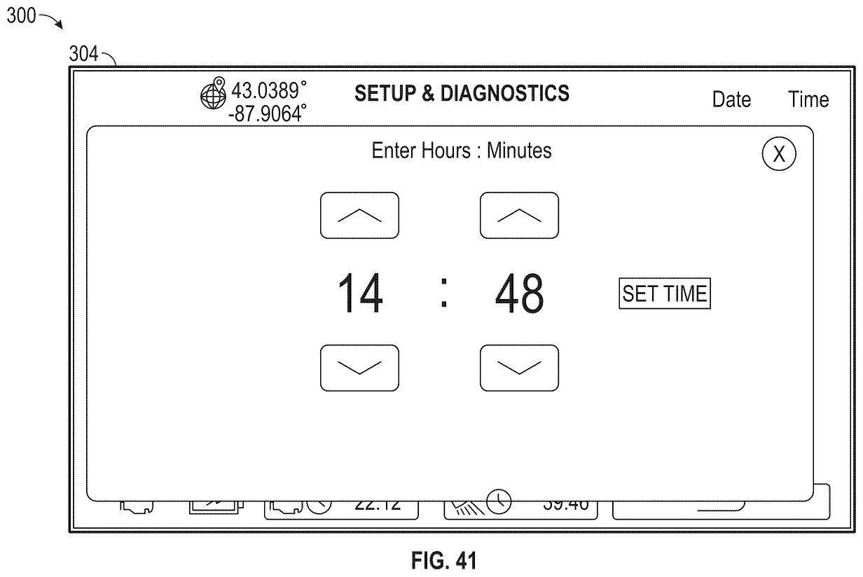

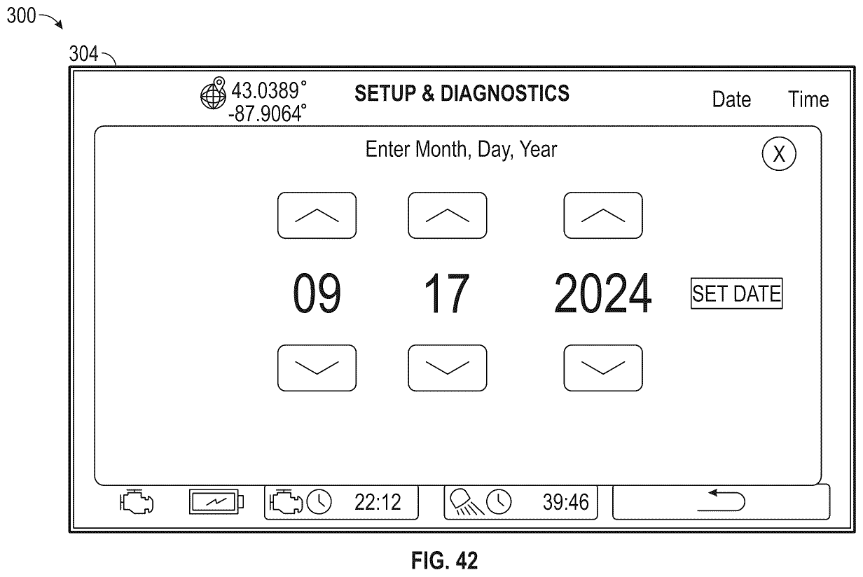

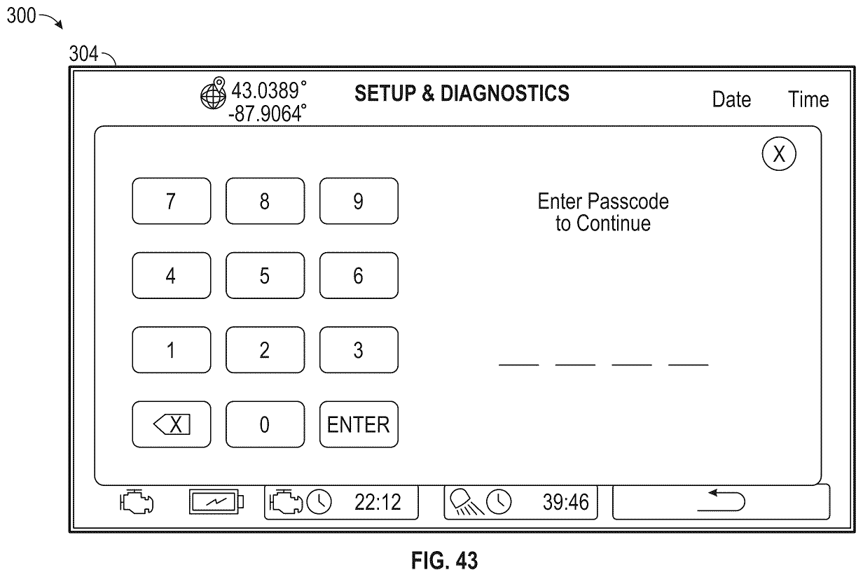

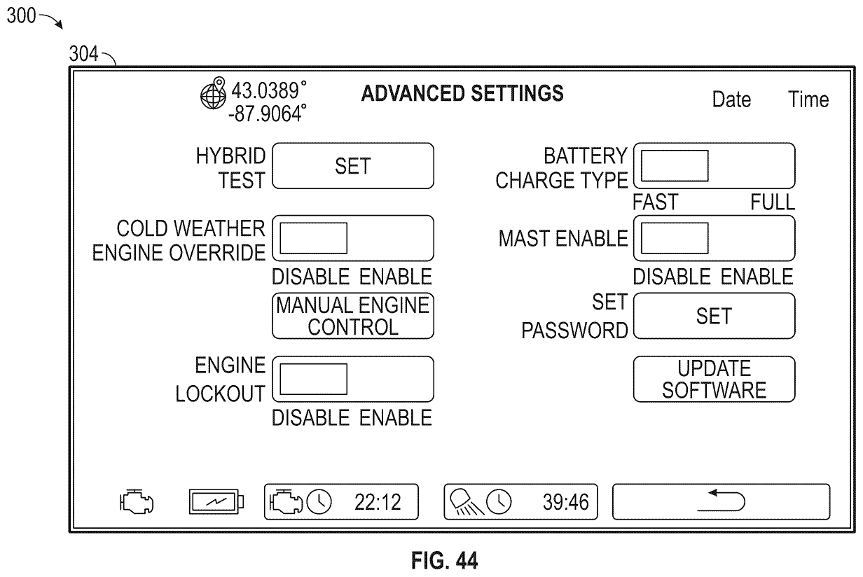

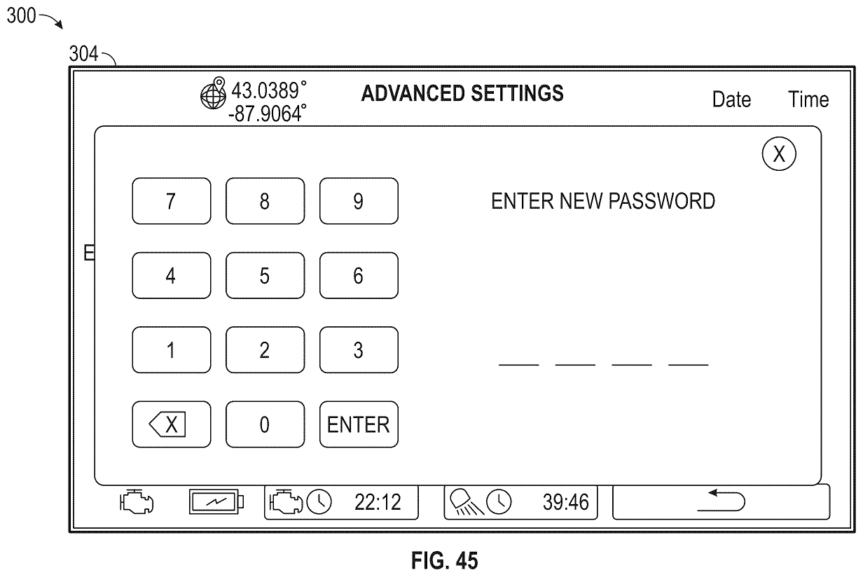

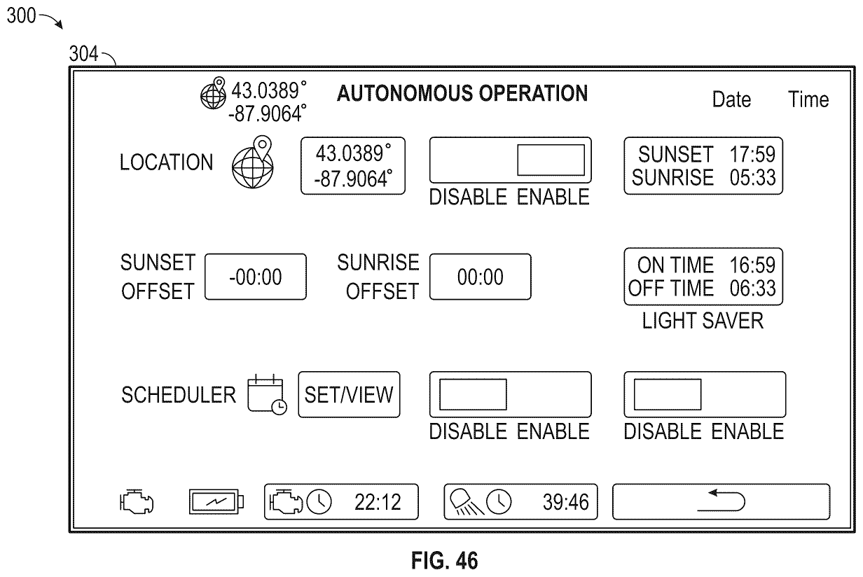

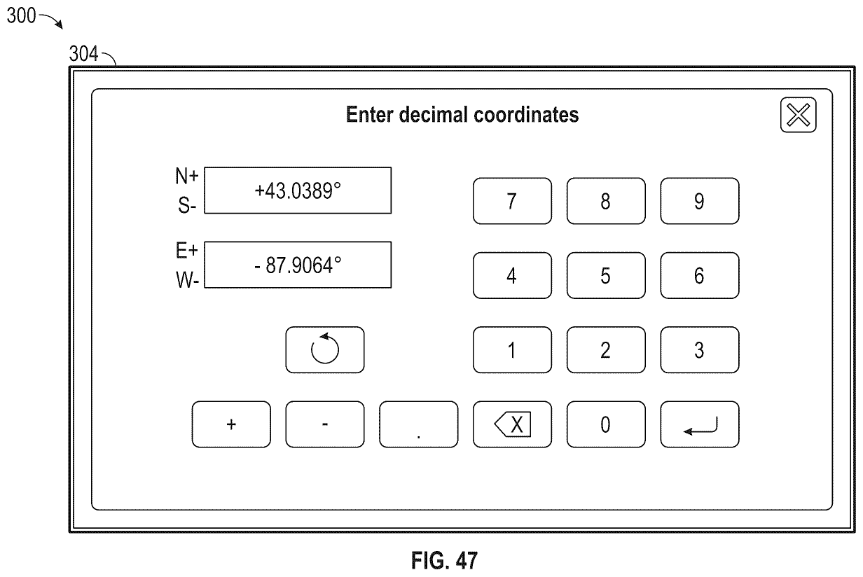

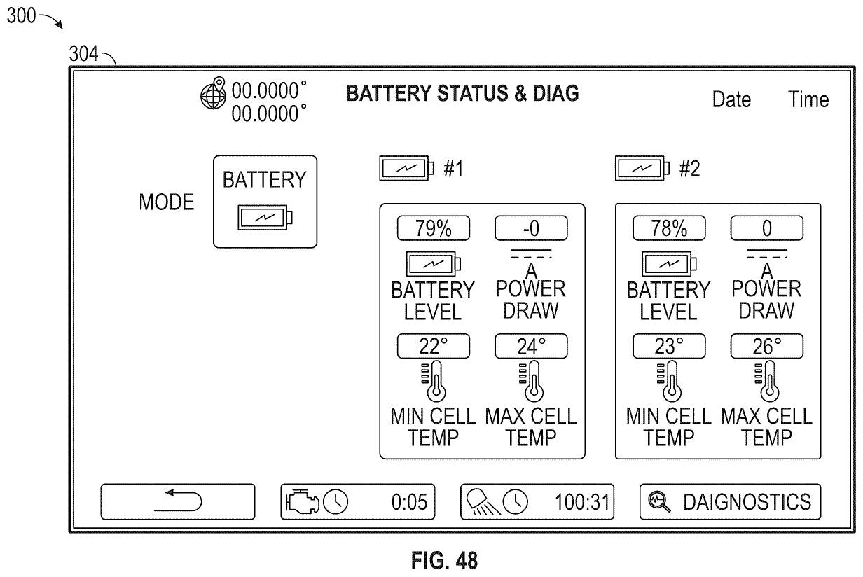

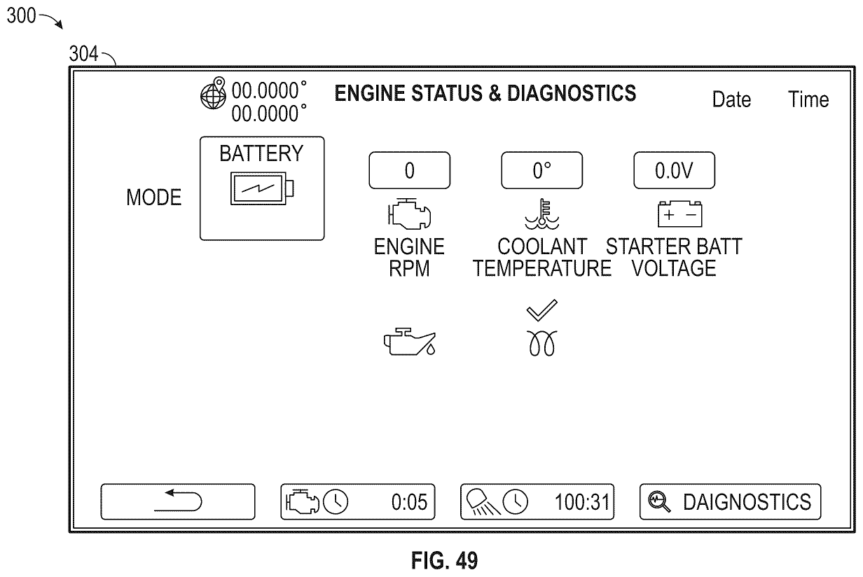

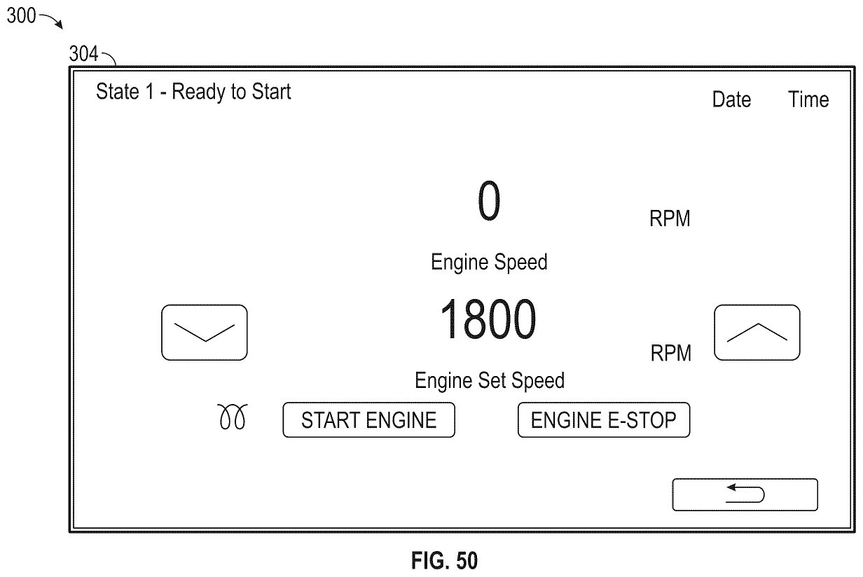

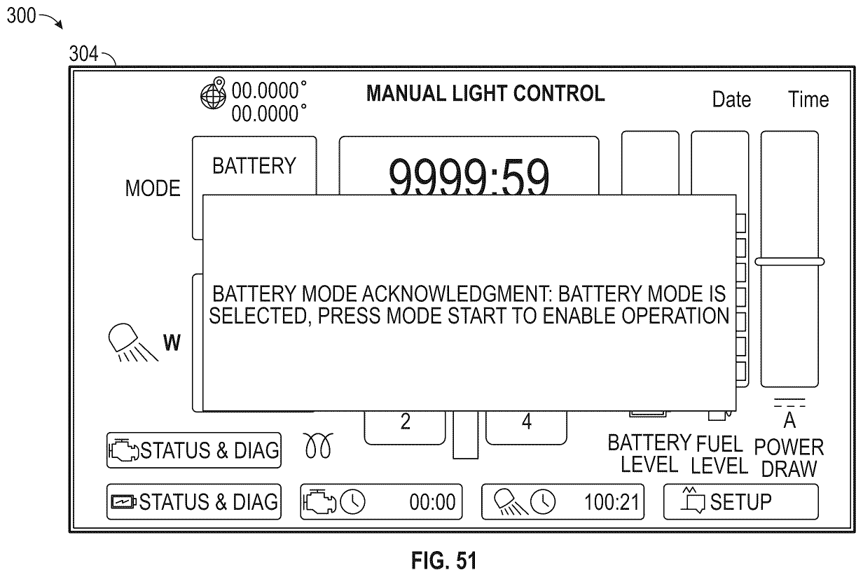

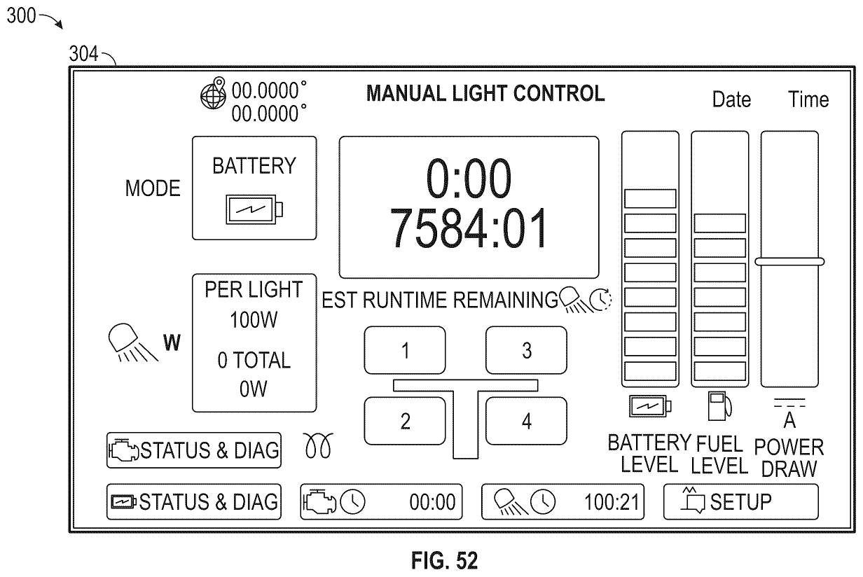

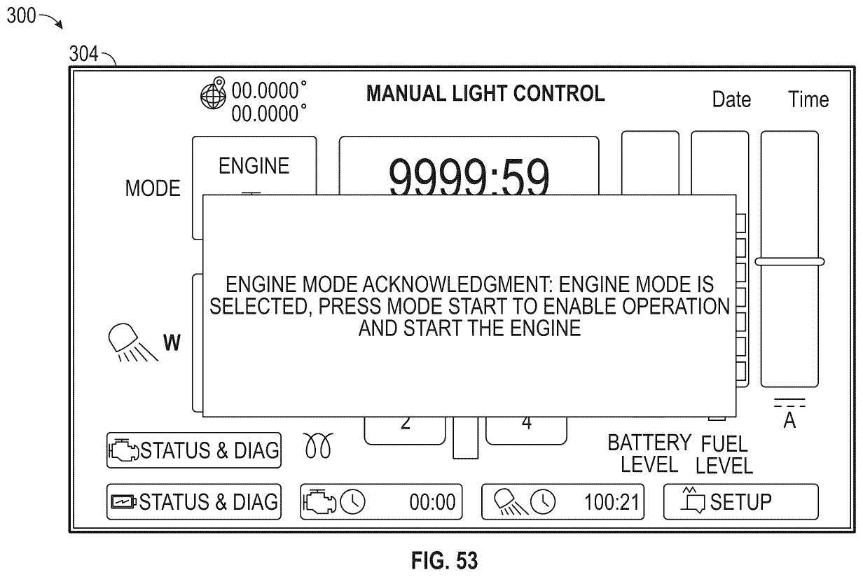

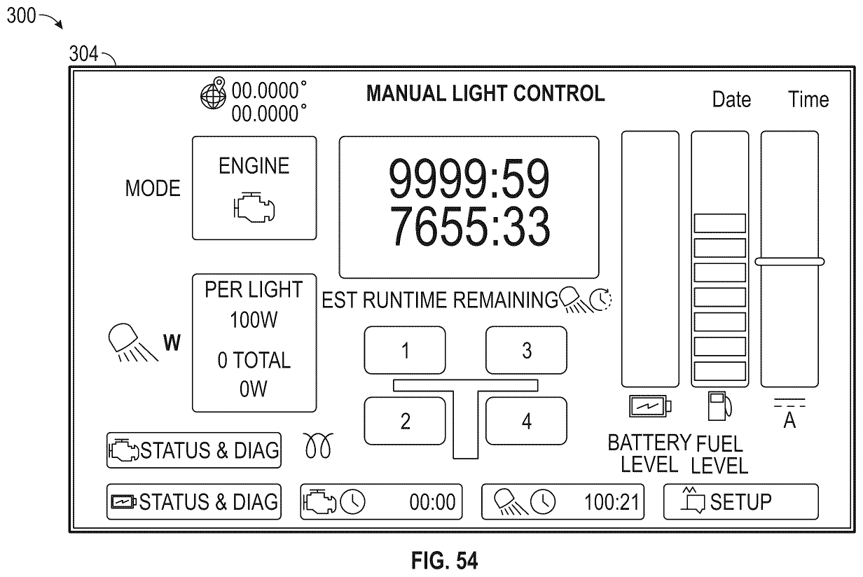

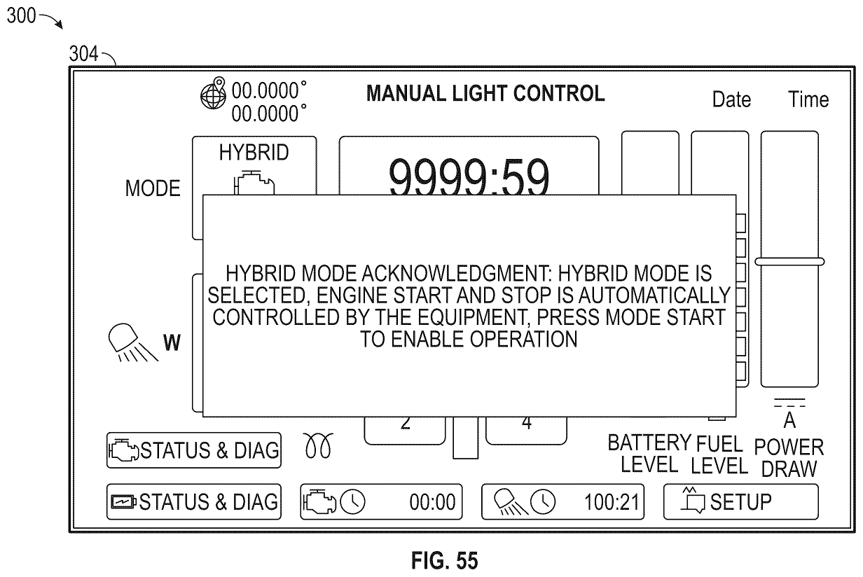

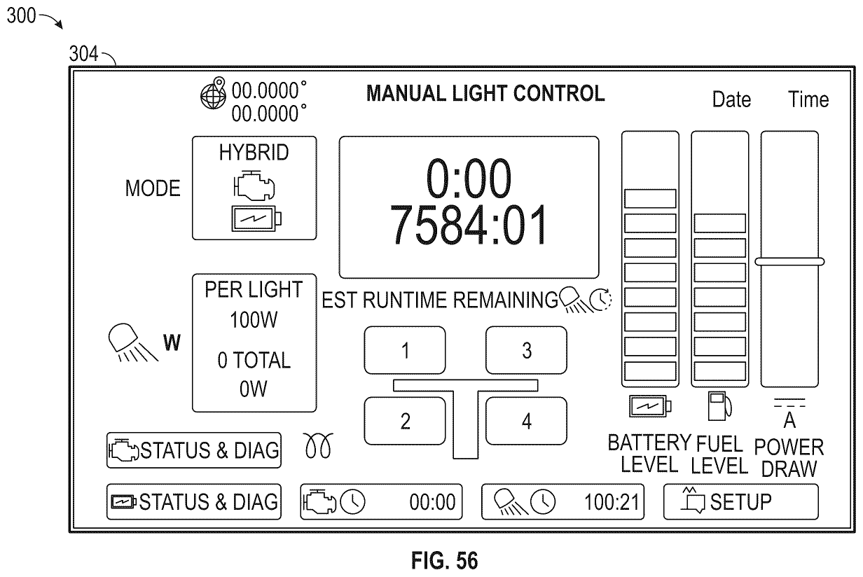

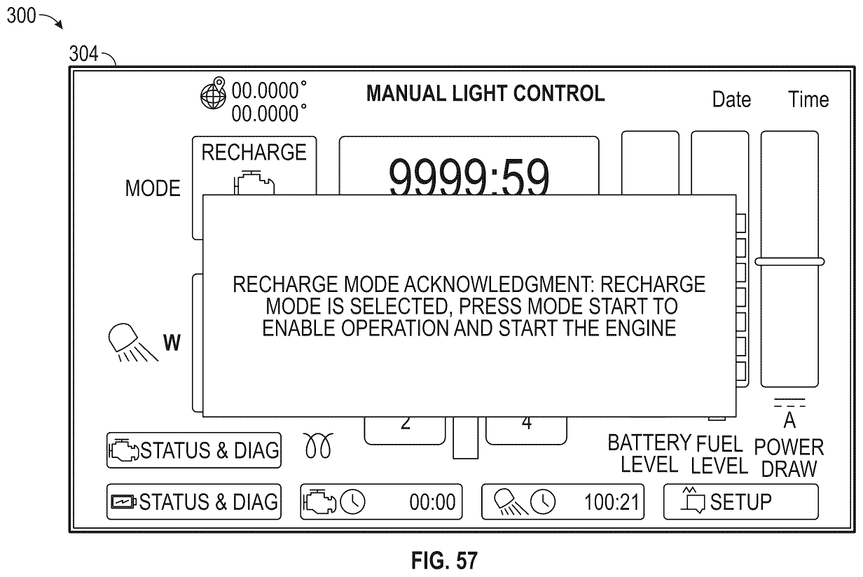

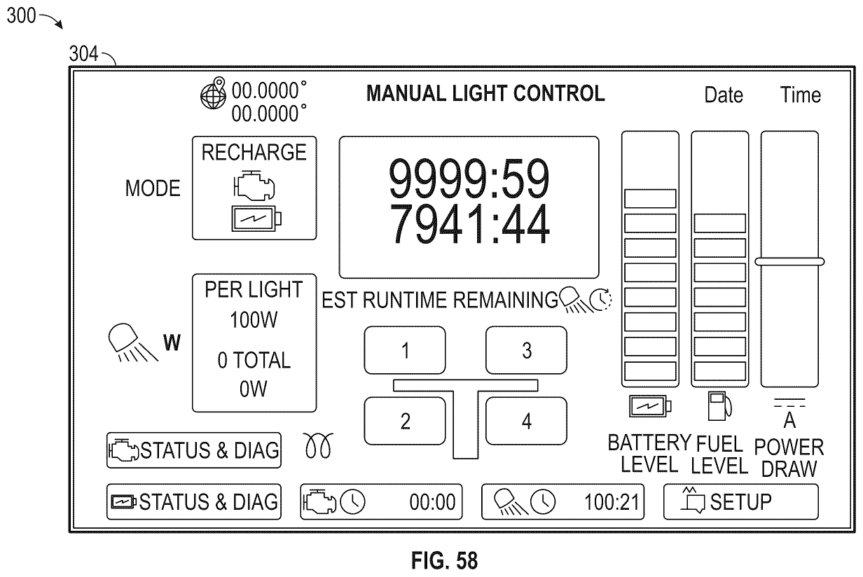

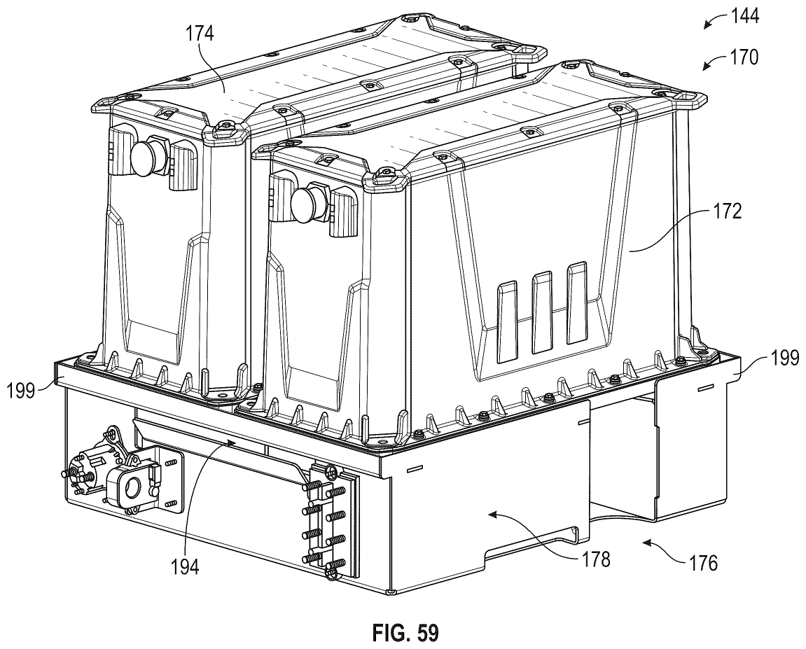

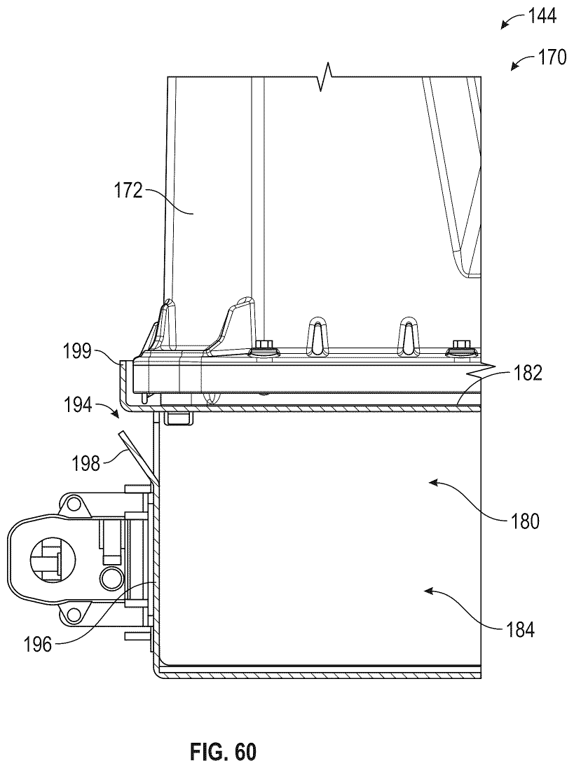

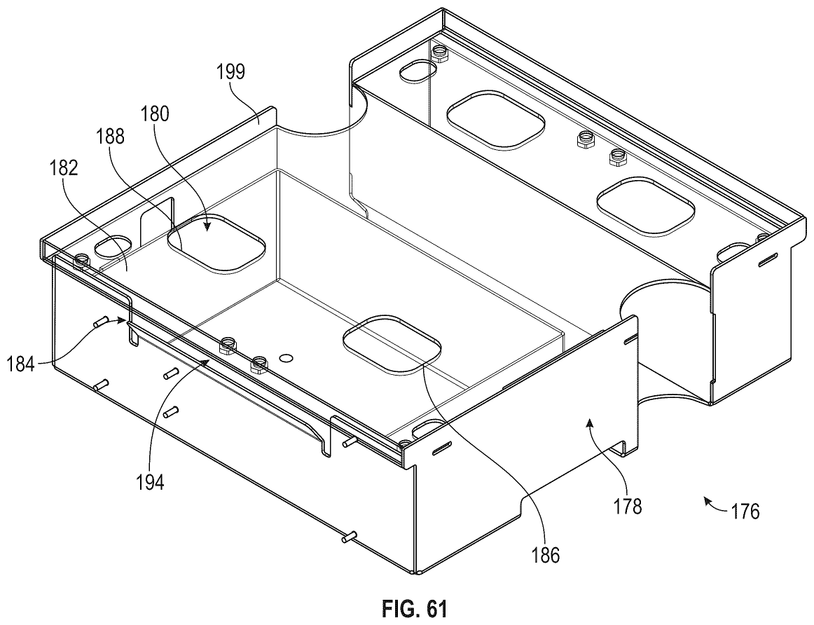

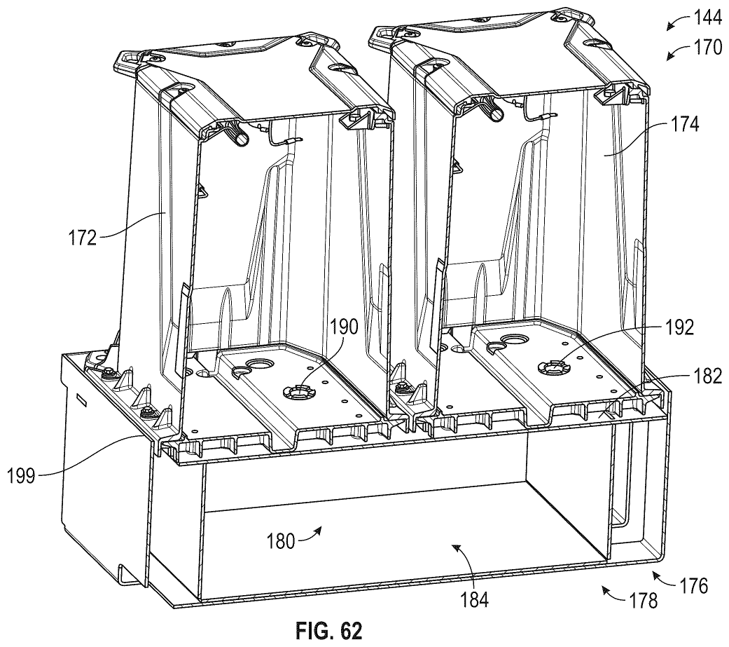

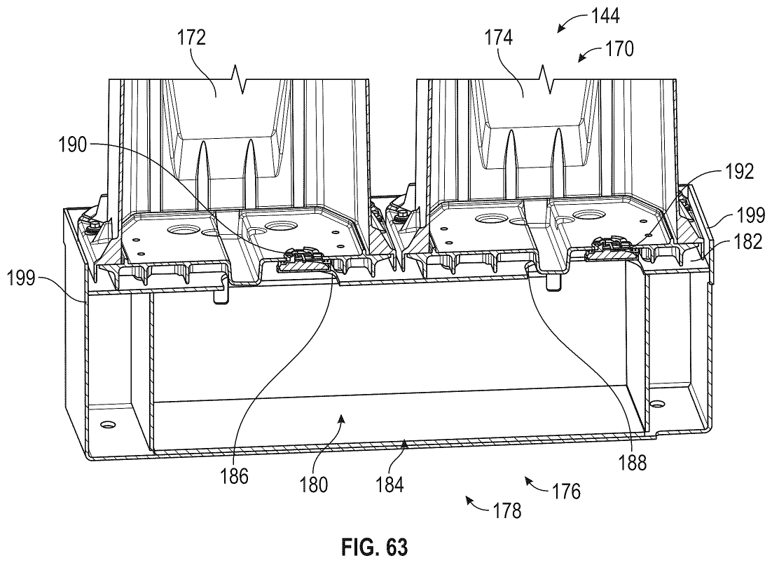

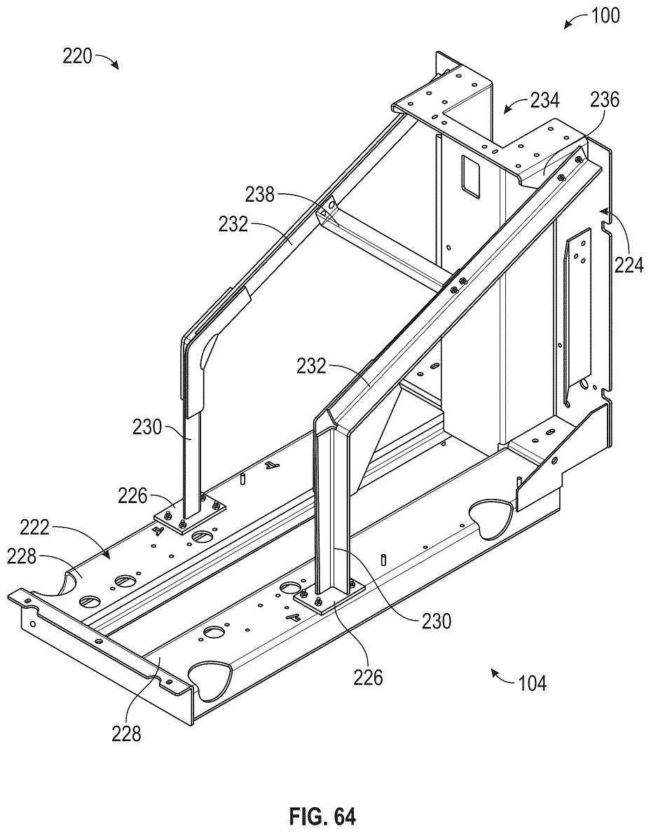

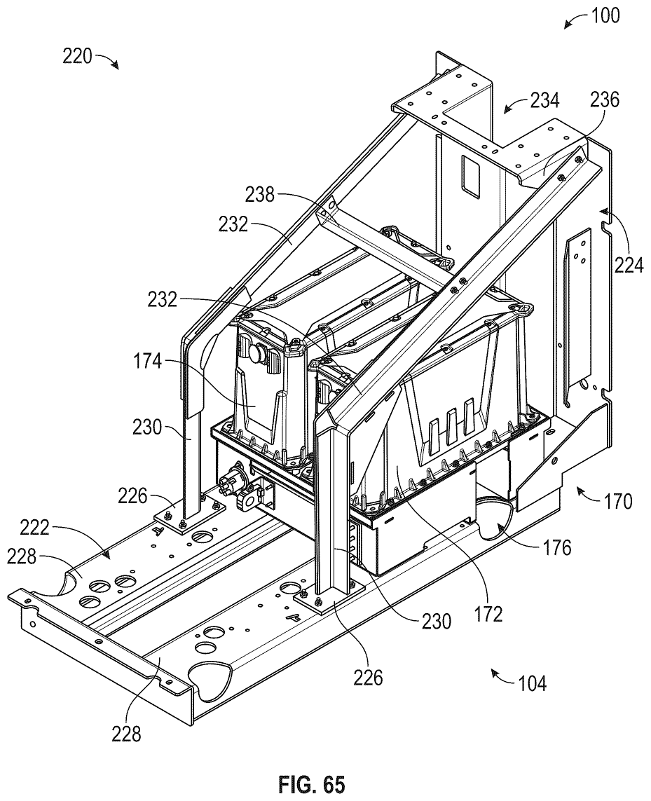

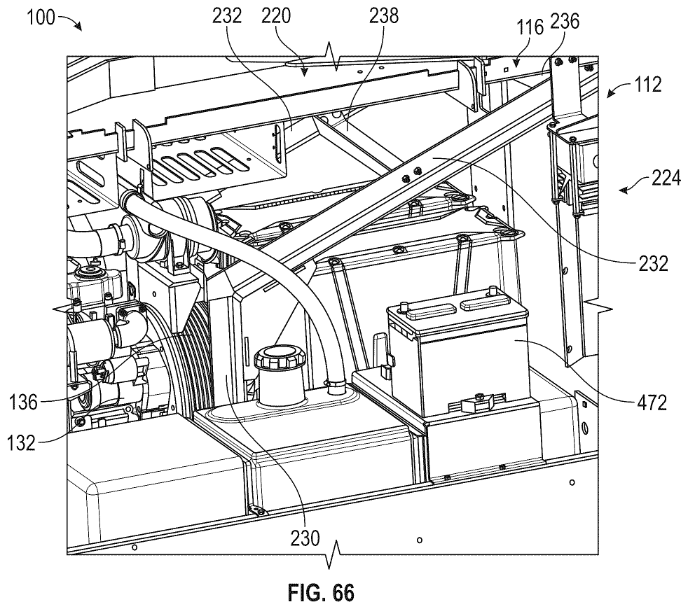

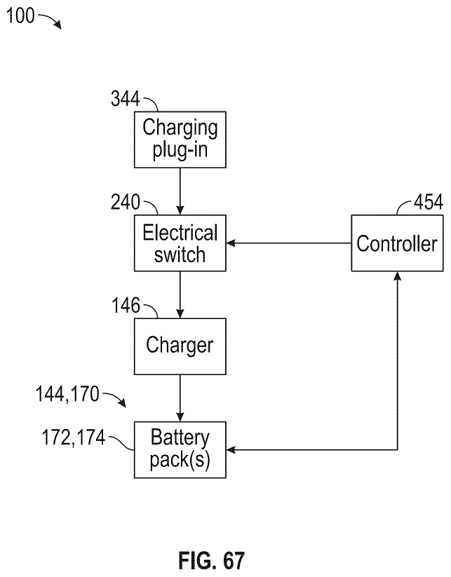

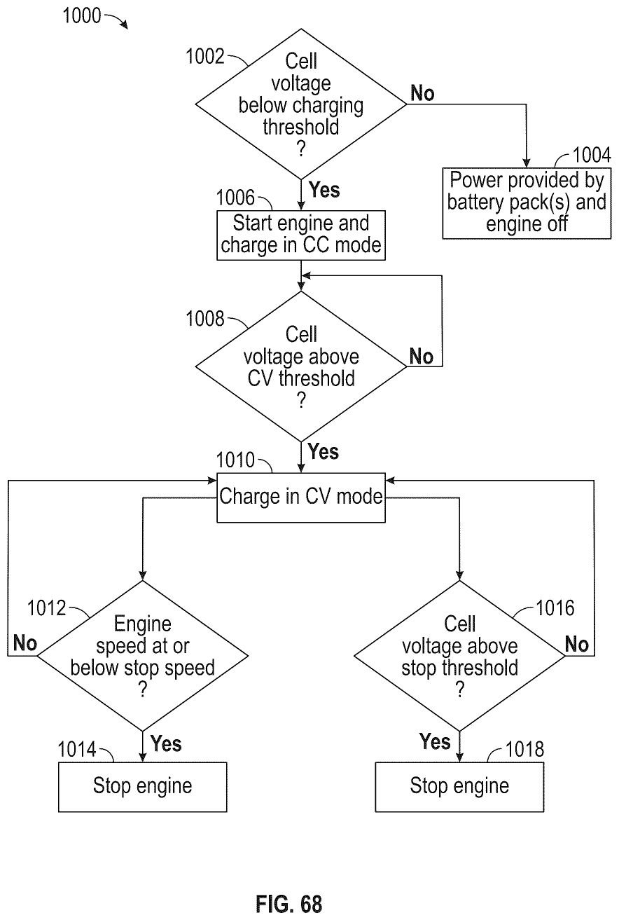

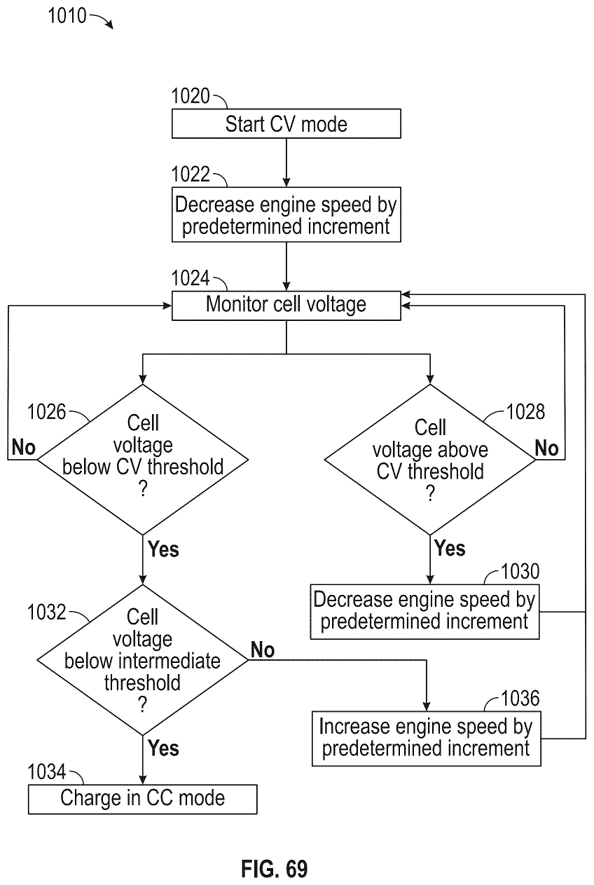

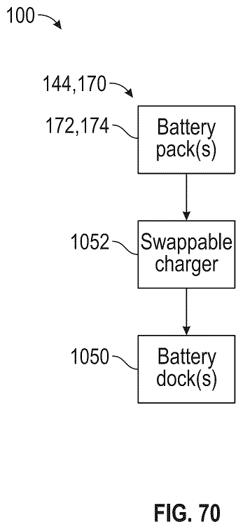

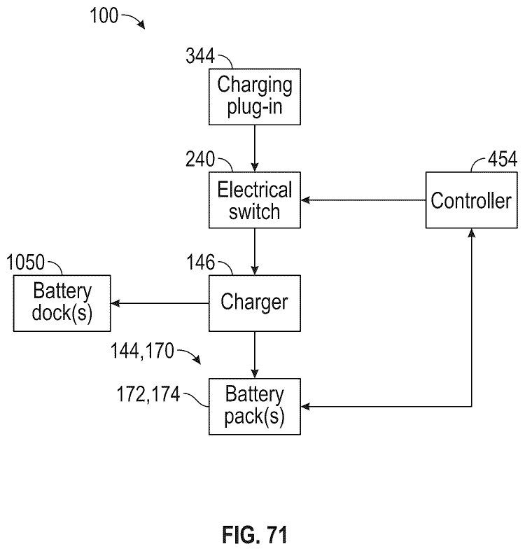

The internal exhaust or vent chamber 180 is formed by an internal frame or box 184 that is at least partially arranged within the outer frame 178. The internal frame 184 includes an open top side. The outer frame 178 includes a first exhaust cutout 186 and a second exhaust cutout 188 that both extend through the top surface 182 (see, e.g., FIG. 33). The first battery pack 172 includes a first vent 190 formed in a bottom wall thereof, and the second battery pack 172 includes a second vent 192 formed in a bottom wall thereof (see, e.g., FIGS. 34 and 35). The first vent 190 is positioned over the first exhaust cutout 186 so that fluid flow is allowed through the first vent 190 and the first exhaust cutout 186, and into the internal exhaust chamber 180 (see, e.g., FIG. 35). Similarly, the second vent 192 is positioned over the second exhaust cutout 188 so that fluid flow is allowed to flow through the second vent 192 and the second exhaust cutout 188, and into the internal exhaust chamber 180. In some embodiments, in addition to the flow path into the internal exhaust chamber 180, a bottom surface of the first battery pack 172 and the second battery pack 174 may be spaced from the top surface 182 of the outer frame 178 to provide an additional venting flow path.

The internal frame 184 includes an external vent 194 formed along an external wall 196 of the internal frame 184. As shown in FIGS. 30-32, the external vent 194 is formed by an angled portion 198 of the external wall 196 that is spaced from the top surface 182 to define a gap therebetween. The angled portion 198 extends outwardly (e.g., away from the internal exhaust chamber 180) at an acute angle to urge potential exhaust or gas within the internal exhaust chamber 180 to flow upward and rise up into the flow path of the fan 150.

FIGS. 36-38 illustrate an exemplary embodiment of the control panel 300 that includes a CAN panel 200, an emergency stop (E-Stop) button 202, and a start/stop control button 204, in addition to the user interface 304, the mast switch 312, the power switch 316, the power outlet 340, and the charging plug-in 344. In some embodiments, the CAN panel 200 replaces the functionality of the light switches 308, the mode dial 324, and the performance dial 332. In the illustrated embodiment, the CAN panel 200 includes eight buttons or inputs that may be selectively pressed or selected by a user. Specifically, the CAN panel 200 includes a mode selector button 206, an auto mode button 208, an increase intensity button 210, a decrease intensity button 212, and a plurality of light control buttons 214 (see, e.g., FIG. 37).

In general, the mode selector button 206 is configured to change or allow a user to select the operational mode of the light tower 100. For example, pressing the mode selector button 206 may toggle through the various modes (e.g., battery mode 500, hybrid mode 600, engine mode 700, recharge mode 800), with each mode including a unique screen that is displayed on the user interface 304. That is, rather than a user manually turning the mode dial 324 to select the operational mode, the user may press the mode selector button 206 and choose one of the operational modes by stopping when the desired mode is displayed on the user interface 304. It should be appreciated that the control and operation of the light tower 100 in the battery mode (e.g., the battery mode 500), the hybrid mode (e.g., the hybrid mode 600), the engine mode (e.g., the engine mode 700), and the recharge mode (e.g., the recharge mode 800) remains the same, but the process of selecting the mode is governed by the mode selector button 206. The CAN panel 200 is in communication with the controller 454, which is configured to relay instructions from the CAN panel 200 to the engine controller 458, the battery management system 145, and/or the lights 156 (see, e.g., FIG. 38). In some embodiments, the controller 454 is configured to require a secondary authorization or confirmation of a mode that is selected by the mode selector button 206. For example, in response to a user selecting, via the mode selector button 206, the hybrid mode, the engine mode, or the recharge mode, the controller 454 may require an input to the start/stop control button 204 to enable operation in the selected mode.

The auto mode button 208 may toggle the autonomous mode (e.g., the autonomous mode 900) on and off. When the auto mode button 208 enables the autonomous mode, the lights 156 may be automatically controlled according to a set, programmed schedule or in reference to sunrise and sunset, as described herein. The increase light intensity button 210 and the decrease light intensity button 212 are configured to increase and decrease, respectively, a light intensity of all of the lights 156. The controller 454 is configured to update an available runtime that is displayed on the user interface 304 in response to changes to the light intensity received by the increase light intensity button 210 and the decrease light intensity button 212.

In the illustrated embodiment, the plurality of light control buttons 214 includes four buttons, one for each of the lights 156 in the light assembly 140. In some embodiments, the CAN panel 200 may include more or less than four light control buttons 214 to correspond with the number of lights 156 in the light assembly 140. Each of the light control buttons 214 is configured to control or toggle an on/off status of one of the lights 156 based on a user pressing the light control button 214. The E-Stop button 302, when pressed, is configured to shutdown the engine 132 and the controller 454 is configured to control shutdown of all remaining functions once the controller 454 detects that the E-Stop button 302 has been pressed.

Turning to FIG. 38, the controller 454 is in communication with the generator 136, the BMS 145, the lights 156, the fan controller 162, the control panel 300, one or more sensors 440, and the engine controller 458. In some embodiments, each of the first battery pack 172 and the second battery pack 174 includes a dedicated BMS that both communicate with the controller 454. In some embodiments, the first battery pack 172 and the second battery pack 174 include a common BMS. Regardless of the particular BMS implementation, the controller 454 is configured to monitor performance and operating characteristics (e.g., SOC, charge current, discharge current, cell temperature, cell voltage, etc.) of the first battery pack 172 and the second battery pack 174 and attempt to maintain the SOC of the first battery pack 172 and the second battery pack 174 in a balanced stated (e.g., within a predetermined differential from one another). In some embodiments, if one of the first battery pack 172 or the second battery pack 174 needs to go offline and the contactor opens preventing the battery from being used, the controller 454 and/or the BMS 145 may instruct both of the first battery pack 172 and the second battery pack 174 to turn off together to maintain the SOC of the first battery pack 172 and the second battery pack 174 within the predetermined differential.

In some embodiments, the controller 454 is configured to operate one or more components of the light tower 100 in a light sleep mode or a deep sleep mode. In some embodiments, the controller 454 is configured to transition into the light sleep mode after not receiving an input from the control panel 300 for a predetermined waiting period (e.g., 1 minute, 2 minutes, 3 minutes, etc.), or after instructing the user interface 304 to display a notification for the predetermined waiting period. Once the conditions for entering light sleep mode are satisfied, the controller 454 is configured to turn of the display or screen of the user interface 304, which reduces a power demand on a 12V battery 472 that, in some embodiments, provides power to the controller 454, the CAN panel 200, among other components within the light tower 100. In some embodiments, the 12V battery 472 is charged via an alternator of the engine 132, when the engine 132 is running, and charged by either a DC-to-DC battery charger that is powered by the battery 144/the battery assembly 170 or an AC-to-DC battery charger that is powered by the inverter 138 (which is powered by the battery 144/the battery assembly 170).

In some embodiments, once the light sleep mode has been active for a predetermined sleep period (e.g., 1 hour, 1.5 hours, 2, hours, etc.), the power switch 316 is still in the on position, and the light assembly 140 is not operational (e.g., due to a missed secondary authorization, an interrupted charging condition that has not been resumed, or after running in battery mode and reaching the low SOC threshold), the controller 454 transitions into the deep sleep mode. In the deep sleep mode, the first battery pack 172 and the second battery pack 174 are shutdown, any lights associated with the CAN panel 200 are turned off, and the display or screen on the user interface 304 is turned off. In this way, for example, the power draw from the 12V battery 472 is significantly reduced in the deep sleep mode to maintain available power to allow the controller 454 to “wake up” in predetermined wake-up intervals (e.g., 2 hours, 4 hours, 6 hours, etc.) and broadcast the deep sleep status via telematics.

As described herein, the controller 454 is configured to define a low SOC threshold (e.g., the SOC threshold where the battery assembly 170 is allowed to drain down to before the engine 132 initiates charging the battery assembly 170 via the generator 136), in both the battery and hybrid modes, that may be based on a battery cell temperature that is communicated to the controller 454 from the BMS 145. In some embodiments, the BMS 145 communicates signals to the controller 454 relating to the maximum and minimum battery cell temperature for both the first battery pack 172 and the second battery pack 174. In general, adjusting the low SOC threshold based on battery cell temperature prepares the battery assembly 170 for going offline and being stored for an extended period of time. In some embodiments, when operating in the hybrid mode (e.g. the hybrid mode 600), when the minimum battery cell temperature of the battery assembly 170 (i.e., either the first battery pack 172 or the second battery pack 174) is above a first temperature threshold, the low SOC threshold is set to a first value, and when the minimum battery cell temperature of the battery assembly 170 is below the first temperature threshold, the low SOC threshold is set to a second value that is greater than the first value. Once the low SOC threshold is set to the second value, the low SOC threshold may remain at the second value until the minimum battery cell temperature of the battery assembly 170 increases to a second temperature threshold that is greater than the first temperature threshold. Once the minimum battery cell temperature reaches the second temperature threshold, the low SOC threshold is set back to the first value. In some embodiments, if the minimum battery cell temperature drops below the first temperature threshold after the SOC has already dropped below the second value, the controller 454 instructs the engine controller 458 to initiate a full recharge cycle where the engine 132 powers the generator 136 to recharge the battery assembly 170.

In general, when operating in the battery mode (e.g., the battery mode 500) where engine/generator recharging is not an option, once the low SOC threshold is reached, the light assembly 140 is turned off and the controller 454 will transition to the light sleep mode and then the deep sleep mode pending user interaction. In some embodiments, when operating in the battery mode (e.g., the battery mode 500), when the minimum battery cell temperature of the battery assembly 170 (i.e., either the first battery pack 172 or the second battery pack 174) is above a first temperature threshold, the low SOC threshold is set to a first value by the controller 454, and when the minimum battery cell temperature of the battery assembly 170 is below the first temperature threshold, the low SOC threshold is set to a second value that is greater than the first value. In some embodiments, the first temperature threshold in the battery mode is different than (e.g., less than) the first temperature threshold in the hybrid mode. In some embodiments, the first value of the low SOC threshold is the same for both the battery mode and the hybrid mode. In some embodiments, the second value of the low SOC threshold in the battery mode is different than (e.g., less than) the second value of the low SOC threshold in the hybrid mode.

In some embodiments, when operating in the battery mode and once the low SOC threshold is set to the second value, the low SOC threshold may remain at the second value until the minimum battery cell temperature of the battery assembly 170 increases to a second temperature threshold that is greater than the first temperature threshold. Once the minimum battery cell temperature reaches the second temperature threshold, the low SOC threshold is set back to the first value. In some embodiments, the second temperature threshold in the battery mode is the same as the second temperature threshold in the hybrid mode. In some embodiments, if the minimum battery cell temperature drops below the first temperature threshold and the SOC is already below the low SOC threshold, the controller 454 instructs the user interface 304 to display a notification informing a user to recharge the battery assembly 170 or select another operating mode (e.g., hybrid mode, recharge mode, etc.). If nothing changes in the operation of the light tower 100 after a predetermined waiting period (e.g., 1 minute, 2 minutes, 3 minutes, etc.), the controller 454 turns off the light assembly 140 and will transition to the light sleep mode and then the deep sleep mode. In some embodiments, during normal operating conditions in the battery mode (e.g., the SOC is above the low SOC threshold), the controller 454 may provide the notification informing a user to recharge the battery assembly 170 or select another operating mode a predetermined SOC value above the low SOC threshold (e.g., 5% above the low SOC threshold, 10% above the low SOC threshold, etc.).

In some embodiments, the controller 454 is configured to control a speed of the engine 132 during charging operations, via communication with the engine controller 458, based on a current output from the generator 136 and the maximum charging current available from the battery assembly 170. For example, the one or more sensors 440 may include a current sensor that measures a current output from the generator 136. The current measured output from the generator 136 measured by the current sensor is a function of the load from the light assembly 140 and the inverter 138. The current flowing into the battery assembly 170 (i.e., into the first battery pack 172 and the second battery pack 174) is measured by the BMS 145 and communicated to the controller 454. In addition, the BMS 145 also communicates the maximum charge current available for the battery assembly 170 to the controller 454, which is based on, for example, the maximum and minimum battery cell temperatures of each of the first battery pack 172 and the second battery pack 174.

In some embodiments, the generator 136 is restricted during operation to output a maximum generator current. This maximum generator current is used in combination with the current output from the generator 136 that is measured by the current sensor to determine a maximum charge available for each of the first battery pack 172 and the second battery pack 174. For example, the difference between the maximum generator current and the sensed current output from the generator is averaged for the number of battery packs (e.g., divided by 2 in the exemplary embodiment including two battery packs). This value provides the maximum charge available per battery. In some embodiments, the controller 454 determines the minimum value of the two maximum charge currents for the battery assembly 170 provided by the BMS 145 (e.g., maximum charge current for the first battery pack 172 and the maximum charge current for the second battery pack 174, which should be close due to the first battery pack 172 and the second battery pack 174 not varying much in temperature), and sets a target maximum charge rate for the battery assembly 170 at a predetermined margin or tolerance below this minimum value.

When determining the charge rate for the battery assembly 170, the controller 454 compares the target maximum charge rate to the maximum charge available from the generator 136. Specifically, if the target maximum charge rate is greater than or equal to the maximum charge available, then the charge rate is set to the maximum charge available. If the target maximum charge rate is less than the maximum charge available, then the charge rate is set to the target maximum charge rate. The current into the battery assembly 170 (e.g., the current flow into each of the first battery pack 172 and the second battery pack 172) is measured either by a battery current sensor of the one or more sensors 440 and/or by the BMS 145. If the current flowing into the first battery pack 172 or the second battery pack 174 is greater than the charge rate, the controller 454 instructs the engine 132 to decrease speed. If the current flowing into the first battery pack 172 and the second battery pack 174 is less than the charge rate, the controller 454 instructs the engine 132 to increase speed.

In some embodiments, the controller 454 is configured to control a speed of the engine 132 during engine mode operations, via communication with the engine controller 458. In engine mode, the light assembly 140 and the inverter 138 are powered by the output of the generator 136 and no current is being used to charge the battery assembly 170, which is offline. The maximum charge rate from the battery assembly 170 is, therefore, assumed to be zero when the battery assembly 170 is offline. Accordingly, the controller 454 is configured to control the speed of the engine 132 to match the current demand of the current sensor that monitors the loads required by the light assembly 140 and the inverter 138.

As described herein and shown in FIG. 39, the controller 454 is in communication with the fan controller 162. In general, the controller 454 is configured to instruct the fan controller 162 to control a speed and direction of the fan 150 based, for example, of both the coolant temperature within the coolant circuit of the engine 132 and the battery cell temperature within the battery assembly 170. In some embodiments, the coolant temperature may be used to control a speed of the fan 150, with the fan 150 being off when the coolant temperature is below a low temperature threshold and the fan 150 at a first speed when the coolant temperature is above the low temperature threshold. The controller 454 may define various incremental step changes in fan speed as the coolant temperature increases above the low temperature threshold. For example, when the coolant temperature increases above a second temperature threshold, the fan 150 may increase to a second speed higher than the first speed, and when the coolant temperature increases above a third temperature threshold, the fan 150 may increase to a third speed higher than the second speed, and so on. In some embodiments, the battery cell temperature may be used to control a direction of the fan 150. If the battery cell temperature is greater than or equal to a first temperature threshold, the controller 454 instructs the fan 150 to operate in the first operating mode where the fan 150 rotates in the first direction (see, e.g., FIGS. 25-28). If the battery cell temperature is less than the first temperature threshold, the controller 454 instructs the fan 150 to operate in the second operating mode where the fan 150 rotates in the second direction (see, e.g., FIG. 28). In the second operating mode, the fan 150 draws warm air from the radiator 154 to warm the enclosure 116 and the battery assembly 170. Once the fan 150 is transitioned to the second operating mode, the controller 454 will maintain the fan 150 in the second operating mode until the battery cell temperature increases above a second temperature threshold that is greater than the first temperature threshold. When the battery cell temperature increases above the second temperature threshold, the controller 454 instructs the fan 150, via the fan controller 162, to transition back to the first operating mode.

FIGS. 40-58 show exemplary embodiments of various screens that may be displayed on the user interface 304 of the control panel 300. For example, FIG. 40 shows a setup and diagnostic screen. FIG. 41 shows a time entry screen where the time of day may be entered into the controller 454. FIG. 42 shows a date entry screen where the date may be entered into the controller 454. FIG. 43 shows a passcode screen where a user is prompted to enter a password, for example, to access an advanced setting screen. FIG. 44 shows an advanced setting screen, and FIG. 45 shows a new password screen.

FIG. 46 shows an autonomous operation screen where the location and schedule of the light assembly 140 may be controlled or viewed in the autonomous mode. FIG. 47 shows a location screen where a geographic location may be entered into the controller 454. FIG. 48 shows a battery status and diagnostic screen, and FIG. 49 shows an engine status and diagnostic screen. FIG. 50 shows an engine speed screen where a speed of the engine 132 may be manually controlled based on an input to the user interface 304.

FIG. 51 shows a light control screen after a user selected, for example, via the CAN panel 200, the battery mode and the user interface 304 prompts the user for secondary authorization to proceed with the battery mode (e.g., requiring the start/stop control button 204 to be pressed). FIG. 52 shows the light control screen after the secondary authorization occurs in battery mode. FIG. 53 shows a light control screen after a user selected, for example, via the CAN panel 200, the engine mode and the user interface 304 prompts the user for secondary authorization to proceed with the engine mode (e.g., requiring the start/stop control button 204 to be pressed). FIG. 54 shows the light control screen after the secondary authorization occurs in engine mode. FIG. 55 shows a light control screen after a user selected, for example, via the CAN panel 200, the hybrid mode and the user interface 304 prompts the user for secondary authorization to proceed with the hybrid mode (e.g., requiring the start/stop control button 204 to be pressed). FIG. 56 shows the light control screen after the secondary authorization occurs in hybrid mode. FIG. 57 shows a light control screen after a user selected, for example, via the CAN panel 200, the recharge mode and the user interface 304 prompts the user for secondary authorization to proceed with the recharge mode (e.g., requiring the start/stop control button 204 to be pressed). FIG. 58 shows the light control screen after the secondary authorization occurs in recharge mode.

FIGS. 59-63 show an exemplary embodiment of the mounting assembly 176 for the battery assembly 170 including an upper flange 199. In general, the mounting assembly 176 of FIGS. 59-63 is similar to the mounting assembly 176 of FIGS. 31-35, with like features identified using the same reference numerals, except as described herein or as apparent from the figures. In the illustrated embodiment, the mounting assembly 176 includes the upper flange 199 extending around a periphery of the top surface 182. Specifically, the upper flange 199 extends outwardly and away from the top surface 182 to form a lip that surrounds a base of the battery assembly 170 (e.g., surrounds the first battery pack 172 and the second battery pack 174). In some embodiments, the upper flange 199 is formed along the sidewalls of the outer frame 178 (e.g., sides arranged perpendicular to the external wall 196 including the external vent 194) by the external walls extending above the top surface 182 (see, e.g., FIGS. 62 and 63). In some embodiments, the upper flange 199 is formed along the front and back sides of the outer frame 178 (e.g., side including the external wall 196 and the opposing side) as an integral feature with the top surface 182.

FIGS. 64-66 show an exemplary embodiment of the frame 104 of the light tower 100 including stabilizing brackets 220. In the illustrated embodiment, the light tower 100 includes two of the stabilizing brackets 220. In some embodiments, the light tower 100 may include more of less than two of the stabilizing brackets 220. In general, the stabilizing brackets 220 are coupled between a base 222 of the frame 104 and a sidewall 224 of the frame 104, and provide structural stability and support for the battery assembly 170 and the light tower 100, for example, during wind loading. Each of the stabilizing brackets 220 includes a base plate 226 coupled to and supported on the base 222. In some embodiments, the base 222 includes a pair of separated frame rails 228. In some embodiments, the base 222 is formed by a base plate or another structure.

Each of the stabilizing brackets 220 includes a first arm or linkage 230 that extends outwardly from the base plate 226, and an angled arm or linkage 232 that extends from a junction between the first arm 230 and the second arm 232 to the sidewall 224. In the illustrated embodiment, the first arm 230 extends generally perpendicularly from the base plate 226, and the angled arm 232 extends from the junction between the first arm 230 and the second arm 232 at an acute angle (e.g., neither parallel to a top surface of the base 222 nor perpendicular to the top surface of the base 222). For example, the second arm 232 may extend upwardly (e.g., away from the base 222) as the second arm 232 extends from the junction between the first arm 230 and the second arm 232 to the sidewall 224, so that an acute angle (e.g., between approximately 15 degrees and approximately 75 degrees) is formed between a plane that is parallel to the top surface of the base 222 and the second arm 232.

In the illustrated embodiment, a distal end of each of the second arms 232 is coupled to the sidewall 224. Specifically, each of the second arms 232 is coupled to an opposing side of a mast recess or cutout 234 formed in the sidewall 224. The cutout 234 is dimensioned to receive at least a portion of the mast 148, and the second arms 232 are coupled to the sidewall 224 on internal, opposing sides (e.g., within the enclosure 116 formed by the housing 112) of the cutout 234. In some embodiments, the sidewall 224 includes a mounting flange 236 that is coupled to and arranged outwardly from each of the internal, opposing sides of the walls that form the cutout 234, and the distal end of each of the second arms 232 is coupled to the mounting flange 236. By arranging the stabilizing brackets 220 in an area on the frame 104 where the mast 148 interfaces with the frame 104, the stabilizing brackets 220 provide added stability in a location where the frame 104 may experience high loading (e.g., when the 148 is extended).

In the illustrated embodiment, a linkage or crossbar 238 is coupled between (e.g., directly coupled between) the second arms 232 of the stabilizing brackets 220. The crossbar 238 is arranged at a location between the junction between the first arm 230 and the second arm 232, and a distal end of the second arm 232. When the battery assembly 170 is installed on the frame 104 (see, e.g., FIGS. 65 and 66) and the mounting assembly 176 is supported on the frame 104, the stabilizing brackets 220 extend over the battery assembly 170 and the crossbar 238 is arranged above the battery assembly 170.

In some embodiments, the controller 454 may be configured to limit when the battery 144 and/or the battery assembly 170 is allowed to be charged via the charging plug-in 344 (e.g., charged by wall power or shore power) based on the operational mode of the hybrid power system. For example, the light tower 100 may include an electronic switch or relay 240 connected between the charging plug-in 344 and the charger 146 that is on-board the light tower 100 (e.g., within the housing 112 and the enclosure 116), as shown in FIG. 67. In some embodiments, the relay 240 may operate in a normally-closed state, where the relay 240 closes the circuit between the charging plug-in 344 and the charger 146 and enables power transmission therebetween. Accordingly, when the power switch 316 is in an off-state, where the light tower 100 is powered off and no power is being provided by the battery 144, the battery assembly 170, or the engine 132, the relay 240 is configured to allow power transmission from the charging plug-in 344 and the charger 146. Accordingly, when the charging plug-in 344 is connected to an external power source (e.g., wall power or shore power) and the power switch 316 is in an off-state, the battery assembly 170 is charged by electrical power provided by the external power source.

Once the power switch 316 is switched to an on-state and the controller 454 is powered on, the controller 454 is configured to instruct the relay 240 to transition to an open state, where the relay 240 opens the circuit between the charging plug-in 344 and the charger 146 and prevents power transmission therebetween. With the light tower 100 powered on and operating, the controller 454 is configured to prevent the relay 240 from transitioning to the closed state, unless the hybrid power system is operating in the battery mode (e.g., the battery mode 500), where only the battery 144/the battery assembly 170 is allowed to power the light assembly 140. In other words, the controller 454 controls the state of the relay 240 and prevents power transmission between the charging plug-in 344 and the charger 146 in hybrid mode and engine mode. Once the controller 454 detects that the hybrid power system is operating in battery mode, the controller 454 is configured to instruct the relay 240 to transition to the closed state and allow the external power source, when connected to the charging plug-in 344, to supply power to the charger 146 and charge the battery 144/the battery assembly 170. If the controller 454 detects that the hybrid power system is operating in battery mode and the battery 144/the battery assembly 170 is being charged by the external power source (e.g., via signal(s) from the BMS 145), the controller 454 is configured to prevent the hybrid power system from leaving battery mode. Accordingly, when in battery mode, the power switch 316 may need to transition to the off-state or the controller 454 may be required to detect that the battery 144/the battery assembly 170 is not being charged by the external power source to change from the battery mode.

As described herein, in some embodiments, the charging of the battery 144/the battery assembly 170 in hybrid mode (e.g., the hybrid mode 600) may be based on voltage or cell voltage, rather than SOC. Specifically, the controller 454 may control operation of the engine 132 and the charging of the battery assembly 170 by the generator 136 based on the cell voltage communicated to the controller 454 from the BMS 145, as shown in the process or method 1000 of FIG. 68. With the hybrid power system operating in hybrid mode, the battery 144/the battery assembly 170 is prioritized (i.e., used to power the light assembly 140) and the controller 454 monitors a minimum cell voltage communicated from the BMS 145. For example, the BMS 145 of each of the first battery pack 172 and the second battery pack 174 may communicate a minimum cell voltage, and the controller 454 may monitor these values to determine, at step 1002, if the minimum cell voltage is below a charging threshold. If the minimum cell voltage is not below the charging threshold, the battery 144/the battery assembly 170 continues to provide power to the light assembly 140 and the engine 132 remains off at step 1004.

In some embodiments, the charging threshold for the minimum cell voltage may vary as a function of battery temperature (e.g., a minimum cell temperature measured by the BMS 145). Specifically, the charging threshold may define a first value when the battery temperature is above a temperature threshold, and define a second value when the battery temperature is below the temperature threshold, where the first value is less than the second value. In other words, the minimum cell voltage where charging is initiated may be higher when the battery temperature is below the temperature threshold. In some embodiments, once the battery temperature drops below the temperature threshold, the controller 454 does not increase the charging threshold back from the second value (e.g., higher value) to the first value (e.g., lower value) until the battery temperature rises above a second temperature threshold that is greater than the temperature threshold.

If the minimum cell voltage is at or below the charging threshold (e.g., for the corresponding battery temperature), the controller 454 instructs the engine 132 to start and the engine 132 charges the battery 144/the battery assembly 170 in a constant current mode, at step 1006. In the constant current mode, the controller 454 is configured to control a speed of the engine 132 based on the current output from the generator 136 and the maximum charging current available from the battery 144/the battery assembly 170. As described herein, in the constant current mode, the charge rate for the battery 144/the battery assembly 170 is determined by the controller 454 comparing the target maximum charge rate to the maximum charge available from the generator 136. If the target maximum charge rate is greater than or equal to the maximum charge current available, then the charge rate is set to the maximum charge current available. If the target maximum charge rate is less than the maximum charge available, then the charge rate is set to the target maximum charge rate. The current into the battery 144/the battery assembly 170 is measured either by a battery current sensor of the one or more sensors 440 and/or by the BMS 145. If the current flowing into the battery 144/the battery assembly 170 is greater than the charge rate, the controller 454 instructs the engine 132 to decrease speed. If the current flowing into the battery 144/the battery assembly 170 is less than the charge rate, the controller 454 instructs the engine 132 to increase speed.

While in the constant current mode, the controller 454 determines, at step 1008, if a maximum cell voltage measured by the BMS 145 reaches or is equal to a constant voltage threshold. If the maximum cell voltage is below the constant voltage threshold, the engine 132 continues to charge the battery 144/the battery assembly 170 in constant current mode. If the maximum cell voltage reaches or is equal to the constant voltage threshold, the controller 454 controls the engine 132 to charge the battery 144/the battery assembly 170 in a constant voltage mode at step 1010. In general, in the constant voltage mode, the controller 454 controls the speed of the engine 132 to maintain the maximum cell voltage of the battery 144/the battery assembly 170 at the constant voltage threshold, or within a predetermined tolerance or margin of the constant voltage threshold. As the battery 144/the battery assembly 170 are charged in the constant voltage mode, the speed of the engine 132 required to maintain the constant voltage threshold may continually decrease (assuming there are not increases in electrical load, for example, from increases in light intensity of the light assembly 140 or additional loads powered by the inverter 138, which the constant voltage mode adapts to as described herein). The controller 454 is configured to determined, at step 1012, if the speed of the engine 132 decreases to a point where it is equal to a stop speed. If the speed of the engine 132 is not at the stop speed, the charging continues in the constant voltage mode. If the speed of the engine 132 is at the stop speed, the controller 454 instructs the engine 132 to stop, at step 1014 and the battery 144/the battery assembly 170 are charged and can again solely provide power to the light assembly 140.

While in the constant voltage mode, the controller 454 also monitors the maximum cell voltage for any voltage spikes. If the controller 454 determines, at step 1016, that the maximum cell voltage is above a stop threshold (e.g., a predetermined value above the constant voltage threshold), the controller 454 instructs the engine 132 to stop, at step 1018, and the battery 144/the battery assembly 170 are charged and can again solely provide power to the light assembly 140.

Turning to FIG. 69, the operational details of the constant voltage mode at step 1010 in the method 1000 (e.g., between initiation and stopping the engine 132) are shown according to an exemplary embodiment. Once the constant voltage mode is started at step 1020, the controller 454 is configured to decrease the speed of the engine 132, at step 1022, a predetermined increment (e.g., 5 RPM, 10 RPM, 15 RPM, 20 RPM, 25 RPM, 30 RPM, 35 RPM, 40 RPM, 45 RPM, 50 RPM) from the current value, and then monitor the cell voltage from the BMS 145 at step 1024. Specifically, the controller 454 is configured to determine if the maximum cell voltage measured by the BMS 145 is a predetermined tolerance or margin below the constant voltage threshold at step 1026, and determine if the maximum cell voltage measured by the BMS 145 is a predetermined tolerance or margin above the constant voltage threshold at step 1028. In some embodiments, the predetermined margin for being above the constant voltage threshold may be different than the predetermined margin for being below the constant voltage threshold.

If the controller 454 determines that the maximum cell voltage is not the predetermined margin above the constant voltage threshold at step 1028, the controller 454 continues to operate the engine 132 in constant voltage mode and continues to monitor the cell voltage at step 1024. If the controller 454 determines that the maximum cell voltage is the predetermined margin above the constant voltage threshold at step 1028, the controller 454 decreases the speed of the engine 132 by the predetermined increment, at step 1030, and continues to monitor the cell voltage at step 1024.

If the controller 454 determines that the maximum cell voltage is not the predetermined margin below the constant voltage threshold at step 1026, the controller 454 continues to operate the engine 132 in constant voltage mode and continues to monitor the cell voltage at step 1024. If the controller 454 determines that the maximum cell voltage is the predetermined margin below the constant voltage threshold at step 1026, the controller 454 then determines, at step 1032, if the maximum cell voltage decreased to an intermediate threshold that is more than the predetermined margin below the constant voltage threshold and greater than or equal to the charging threshold. If the maximum cell voltage is less than or equal to the intermediate threshold, the controller 454 switches back to the constant current mode (e.g., step 1006) at step 1034. If the maximum cell voltage is greater than the intermediate voltage, the controller 454 increases the speed of the engine 132 by the predetermined increment at step 1036.

Accordingly, the controller 454 is configured to adapt to changes in load (e.g., increases and decreases in load) by controlling the speed of the engine 132, while charging in the constant voltage mode, and the controller 454 will continue to charge in the constant voltage mode until the controller 454 determines that the charging requires switching back to the constant current mode or the speed of the engine 132 reaches the stop threshold (e.g., continuing to decrease via steps 1028 and 1032).

In some embodiments, the light tower 100 may include one or more battery docks 1050 that are each configured to receive a swappable battery pack. The battery docks may receive electrical power from the battery 144/the battery assembly 170 (see, e.g., FIG. 70), or from the charger 146 (see, e.g., FIG. 71), when the external power source is connected and allowed to provide power to the charger 146, to facilitate charging the swappable battery packs connected to the respective battery docks 1050. In some embodiments, the battery docks 1050 are coupled to and/or supported on an external-facing portion of the frame 104. In some embodiments, the battery docks 1050 are coupled to and/or supported on an external-facing portion of the housing 112. In some embodiments, the battery docks 1050 are mounted to and/or arranged within an internal-facing portion of the housing 112 (e.g., the battery docks 1050 are within the enclosure 116). The swappable battery pack(s) and the battery dock 1050 may be in the form of the swappable battery pack and the dock assembly that are described in International Patent Application No. PCT/US2023/033002, filed on Sep. 18, 2023, which is incorporated herein by reference in its entirety.

In the exemplary embodiment where power from the battery 144/the battery assembly 170 is used to charge the swappable battery pack(s) (see, e.g., FIG. 70), the light tower 100 includes a dedicated swappable battery charger 1052. In some embodiments, the swappable battery charger 1052 may be mounted on or within the housing 112, and the swappable battery charger 1052 may receive DC power from the battery 144/the battery assembly 170, when available, and output DC power to the battery docks 1050 (e.g., when a swappable battery is connected to the battery dock 1050).

It should be appreciated that while the hybrid power system (e.g., the engine 132, the generator 136, the battery 144/the battery assembly 170) and the control/operation thereof described herein are applied to the light tower 100, the hybrid power system may be implemented to provide electrical power to other outdoor power equipment applications and/or chore products. For example, the hybrid power system may be applied to chore products, including outdoor power equipment, standby generators, portable jobsite equipment, or other appropriate uses. Outdoor power equipment may include lawn mowers, riding tractors, snow throwers, pressure washers, portable generators, tillers, log splitters, zero-turn radius mowers, walk-behind mowers, wide-area walk-behind mowers, riding mowers, standing mowers, golf carts, construction equipment, cleaning equipment, industrial vehicles such as forklifts, utility vehicles, etc. Portable jobsite equipment may include cleaning equipment, construction equipment, mobile industrial heaters, and portable light stands.

As utilized herein with respect to numerical ranges, the terms “approximately,” “about,” “substantially,” and similar terms generally mean +/−10% of the disclosed values. When the terms “approximately,” “about,” “substantially,” and similar terms are applied to a structural feature (e.g., to describe its shape, size, orientation, direction, etc.), these terms are meant to cover minor variations in structure that may result from, for example, the manufacturing or assembly process and are intended to have a broad meaning in harmony with the common and accepted usage by those of ordinary skill in the art to which the subject matter of this disclosure pertains. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References herein to the positions of elements (e.g., “top,” “bottom,” “above,” “below”) are merely used to describe the orientation of various elements in the FIGURES. It should be noted that the orientation of various elements may differ according to other exemplary embodiments, and that such variations are intended to be encompassed by the present disclosure.

The hardware and data processing components used to implement the various processes, operations, illustrative logics, logical blocks, modules and circuits described in connection with the embodiments disclosed herein may be implemented or performed with a general purpose single- or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function. The memory (e.g., memory, memory unit, storage device) may include one or more devices (e.g., RAM, ROM, Flash memory, hard disk storage) for storing data and/or computer code for completing or facilitating the various processes, layers and modules described in the present disclosure. The memory may be or include volatile memory or non-volatile memory, and may include database components, object code components, script components, or any other type of information structure for supporting the various activities and information structures described in the present disclosure. According to an exemplary embodiment, the memory is communicably connected to the processor via a processing circuit and includes computer code for executing (e.g., by the processing circuit or the processor) the one or more processes described herein.

The present disclosure contemplates methods, systems and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

It is important to note that the construction and arrangement of the light tower 100 as shown in the various exemplary embodiments is illustrative only. Additionally, any element disclosed in one embodiment may be incorporated or utilized with any other embodiment disclosed herein.

What is claimed is:

1. A hybrid light tower, comprising:
a housing;
an engine mounted within the housing;
a mast;
a generator mounted within the housing and configured to be driven by the engine;
a battery mounted within the housing and electrically coupled to the generator;
a light assembly coupled to the mast and including a light, wherein the light is configured to be powered by the battery or the generator; and
a controller in communication with the battery, the engine, and the light assembly, wherein the controller is configured to operate in a hybrid mode where the controller is configured to:
monitor a cell voltage of the battery;
determine if the cell voltage of the battery is below a charging threshold;
upon determining that the cell voltage of the battery is below the charging threshold, start the engine and charge the battery in a constant current mode;
while charging in the constant current mode, determine if the cell voltage is above a constant voltage threshold; and
upon determining that the cell voltage is above a constant voltage threshold, charge the battery in a constant voltage mode.

2. The hybrid light tower of claim 1, wherein the hybrid light tower includes a control panel, and wherein an engine mode, a battery mode, and the hybrid mode are user-selectable via the control panel.

3. The hybrid light tower of claim 2, wherein the control panel includes a controller area network (CAN) pad includes a mode selector button configured to toggle between the engine mode, the battery mode, and the hybrid mode.

4. The hybrid light tower of claim 2, wherein the control panel includes a charging plug-in configured to selectively receive power from an external power source and supply the power from the external power source to a charger.

5. The hybrid light tower of claim 4, wherein the charger is mounted within the housing.

6. The hybrid light tower of claim 1, wherein the controller is further configured to operate in an autonomous mode, wherein in the autonomous mode, the controller is configured to:
receive a time, a date, and a location;
determine a sunrise calculation and a sunset calculation from the time, the date, and the location;
receive a sunrise offset and a sunset offset; and
control the light based on the sunrise calculation, the sunrise offset, the sunset calculation, and the sunset offset.

7. The hybrid light tower of claim 1, wherein the controller is configured to:
monitor a temperature of the battery;
determine if the temperature of the battery is above a temperature threshold;
if the temperature of the battery is above the temperature threshold, set the charging threshold to a first value;
determine if the temperature of the battery is below a temperature threshold; and
if the temperature of the battery is below the temperature threshold, set the charging threshold to a second value, wherein the first value is less than the second value.

8. The hybrid light tower of claim 1, wherein the controller is configured to determine, in the constant current mode, a charge rate for the battery based on a current output from the generator and a maximum charging current available from the battery.

9. The hybrid light tower of claim 8, wherein the controller is configured to:
decrease, in the constant current mode, a speed of the engine if a current flowing into the battery is greater than the charge rate a charge rate for the battery; and
increase, in the constant current mode, a speed of the engine if a current flowing into the battery is less than the charge rate a charge rate for the battery.

10. The hybrid light tower of claim 1, wherein the controller is configured to stop the engine, in the constant voltage mode, when a speed of the engine is less than or equal to a stop speed.

11. The hybrid light tower of claim 1, wherein the controller is configured to:
monitor, in the constant voltage mode, the cell voltage;
determine if the cell voltage is a predetermined margin above the constant voltage threshold;
upon determining that the cell voltage is the predetermined margin above the constant voltage threshold, decrease a speed of the engine by a predetermined increment;
determine if the cell voltage is a predetermined margin below the constant voltage threshold; and
upon determining that the cell voltage is the predetermined margin below the constant voltage threshold, increase the speed of the engine by the predetermined increment.

12. The hybrid light tower of claim 1, wherein the battery is mounted on a mounting assembly that includes an outer frame having an external vent formed in an external wall thereof adjacent to a top surface of the outer frame.

13. The hybrid light tower of claim 1, further comprising a fan arranged within the housing.

14. The hybrid light tower of claim 13, wherein the controller is configured to control a direction of the fan based on a battery cell temperature within the battery.

15. A hybrid light tower, comprising:
a housing;
an engine mounted within the housing;
a mast;
a generator mounted within the housing and configured to be driven by the engine;
a battery mounted within the housing and electrically coupled to the generator;
a light assembly coupled to the mast and including a light, wherein the light is configured to be powered by the battery or the generator;
a control panel including a charging plug-in;
a charger arranged within the housing and electrically coupled to the battery;
an electrical switch electrically coupled between the charging plug-in and the charger; and
a controller in communication with the battery, the engine, the electrical switch, and the light assembly, wherein the controller is configured to selectively switch between a battery mode and a hybrid mode, wherein the controller is configured to control the electrical switch so that:
in the hybrid mode, the electrical switch is configured to prevent power transmission from the charging plug-in to the charger; and
in the battery mode, the electrical switch is configured to allow power transmission from the charging plug-in to the charger.

16. The hybrid light tower of claim 15, wherein the control panel further includes a power switch, and wherein the electrical switch is configured to transition to a closed state and allow power transmission between the charging plug-in and the charger when the power switch is in an off state.

17. The hybrid light tower of claim 16, wherein the controller is configured to transition the electrical switch to an open state and prevent power transmission between the charging plug-in and the charger when the power switch is in an off state and the controller is not in the battery mode.

18. A hybrid light tower, comprising:
a housing defining an enclosure;
an engine arranged within the enclosure;
a mast;
a generator configured to be driven by the engine and arranged within the enclosure;
a battery pack arranged within the enclosure and mounted on a mounting assembly that includes an outer frame and an internal exhaust chamber, wherein the outer frame includes an exhaust cutout and the battery pack includes a vent formed in a bottom surface thereon, wherein the vent is positioned over the exhaust cutout a flow path is provided through the exhaust cutout and into the internal exhaust chamber, wherein the mounting assembly includes an external vent formed in an external wall thereof adjacent to a top surface of the outer frame and in fluid communication with the internal exhaust chamber;
a light assembly coupled to the mast and including a light; and
a controller in communication with the battery pack, the engine, and the light assembly, wherein the controller is configured to operate in an engine mode where the generator supplies power to the light, a battery mode where the battery pack supplies power to the light, or a hybrid mode where the battery pack supplies power to the light and the generator selectively charges the battery pack.

19. The hybrid light tower of claim 18, further comprising a frame on which the battery pack is supported within the housing, and a stabilizing bracket coupled between a base of the frame and a sidewall of the frame.

20. The hybrid light tower of claim 19, wherein the stabilizing bracket includes a first arm extending generally perpendicularly to the base of the frame, and a second arm that extends toward the sidewall at an acute angle.
